(19) United States
(12) Patent Application Publication
(10) Pub. No.: US 2025/0097606 A1
(43) Pub. Date: Mar. 20, 2025

(54) SIGNAL GENERATION CIRCUIT AND PHOTODETECTION APPARATUS

(71) Applicant: Sony Semiconductor Solutions Corporation, Kanagawa (JP)

(72) Inventors: Masahiro Ichihashi, Fukuoka (JP); Hiroki Hidaka, Fukuoka (JP); Kokid Miyamoto, Tokyo (JP)

(21) Appl. No.: 18/727,000

(22) PCT Filed: Dec. 27, 2022
(86) PCT No.: PCT/JP2022/048258

§ 371 Date: Jul. 5, 2024

(30) Foreign Application Priority Data
Feb. 14, 2022 (JP) 2022-020876

(51) Int. Cl. H04N 25/78

(52) U.S. Cl. CPC H04N 25/78

(57) ABSTRACT

A signal generation circuit of the present disclosure includes: a current source that is configured to flow a current from a first power supply node to a first node; a first capacitor that has one end coupled to the first node and another end coupled to a second node; an operation amplifier circuit that has a positive input terminal, a negative input terminal coupled to the second node, and an output terminal coupled to an output node; a first switch that has one end coupled to the second node and another end coupled to the output node; a second capacitor that has one end coupled to the first node and another end coupled to the output node; a first resistor that is provided in a first path that couples the first node and a second power supply node; and a second switch that is provided in the first path and is configured to turn on and off the first path.

### TECHNICAL FIELD

The present disclosure relates to a signal generation circuit that generates a signal having a ramp waveform, and to a photodetection apparatus including such a signal generation circuit.

### BACKGROUND ART

Semiconductor circuits are often provided with signal generation circuits that generate signals having ramp waveforms (see PTL 1, for example)

### CITATION LIST

### Patent Literature

PTL 1: Japanese Unexamined Patent Application Publication No. 2013-85104

### SUMMARY OF THE INVENTION

In signal generation circuits, the dynamic range is desirably made large by widening the range of the voltage of the signal to be generated, and further improvement in dynamic range has been expected.

It is desirable to provide a signal generation circuit and a photodetection apparatus that make it possible to increase the dynamic range of the signal to be generated.

A signal generation circuit of one embodiment of the present disclosure includes a current source, a first capacitor, an operation amplifier circuit, a first switch, a second capacitor, a first resistor, and a second switch. The current source is configured to flow a current from the first power supply node to the first node. The first capacitor has one end coupled to the first node and another end coupled to a second node. The operation amplifier circuit has a positive input terminal, a negative input terminal coupled to the second node, and an output terminal coupled to an output node. The first switch has one end coupled to the second node and another end coupled to the output node. The second capacitor has one end coupled to the first node and another end coupled to the output node. The first resistor is provided in a first path that couples the first node and a second power supply node. The second switch is provided in the first path and is configured to turn on and off the first path.

A photodetection apparatus of one embodiment of the present disclosure includes a photodetection circuit, a signal generation circuit, and a comparison circuit. The photodetection circuit is configured to generate, by detecting light, a detection signal having a voltage dependent on the amount of received light. The signal generation circuit is configured to generate a reference signal whose voltage varies with time. The comparison circuit is configured to perform a comparison operation on the basis of the detection signal and the reference signal. The signal generation circuit includes a current source, a first capacitor, an operation amplifier circuit, a first switch, a second capacitor, a first resistor, and a second switch. The current source is configured to flow a current from a first power supply node to a first node. The first capacitor has one end coupled to the first node and another end coupled to a second node. The operation amplifier circuit has a positive input terminal, a negative input terminal coupled to the second node, and an output terminal coupled to an output node. The first switch has one end coupled to the second node and another end coupled to the output node. The second capacitor has one end coupled to the first node and another end coupled to the output node. The first resistor is provided in a first path that couples the first node and a second power supply node. The second switch is provided in the first path and is configured to turn on and off the first path.

The signal generation circuit and photodetection apparatus of one embodiment of the present disclosure include the current source to make it possible to flow a current from the first power supply node to the first node. The one end of the first capacitor is coupled to the first node, and the other end of the first capacitor is coupled to the second node. The negative input terminal of the operation amplifier circuit is coupled to the second node, and the output terminal of the operation amplifier circuit is coupled to the output node. The one end of the first switch is coupled to the second node, and the other end of the first switch is coupled to the output node. The one end of the second capacitor is coupled to the first node, and the other end of the second capacitor is coupled to the output node. The first resistor and the second switch are provided in the first path that couples the first node and the second power supply node. This second switch is configured to turn on and off this first path.

### BRIEF DESCRIPTION OF DRAWING

FIG. 1 is a block diagram illustrating an example configuration of an imaging device according to one embodiment of the present disclosure.

FIG. 2 is a circuit diagram illustrating an example configuration of the photoreceptor pixel illustrated in FIG. 1.

FIG. 3 is a block diagram illustrating a path for supplying the power supply voltage to the pixel array illustrated in FIG. 1.

FIG. 4 is a circuit diagram illustrating an example configuration of the reference signal generator illustrated in FIG. 1.

FIG. 5 is a timing diagram illustrating an example of the operation of the imaging device illustrated in FIG. 1.

FIG. 6 is a timing waveform diagram illustrating an example of the operation of the imaging device illustrated in FIG. 1.

FIG. 7 is a timing waveform diagram illustrating an example of the operation of the reference signal generator illustrated in FIG. 1.

FIG. 8A is an explanatory diagram illustrating one operating state of the reference signal generator illustrated in FIG. 1.

FIG. 8B is another explanatory diagram illustrating one operating state of the reference signal generator illustrated in FIG. 1.

FIG. 8C is another explanatory diagram illustrating one operating state of the reference signal generator illustrated in FIG. 1.

FIG. 8D is another explanatory diagram illustrating one operating state of the reference signal generator illustrated in FIG. 1.

FIG. 8E is another explanatory diagram illustrating one operating state of the reference signal generator illustrated in FIG. 1.

FIG. 8F is another explanatory diagram illustrating one operating state of the reference signal generator illustrated in FIG. 1.

FIG. 8G is another explanatory diagram illustrating one operating state of the reference signal generator illustrated in FIG. 1.

FIG. 9 is a circuit diagram illustrating one example configuration of a reference signal generator according to a comparative example.

FIG. 10 is a circuit diagram illustrating an example configuration of the reference signal generator according to a reference example.

FIG. 11 is a circuit diagram illustrating an example configuration of a reference signal generator according to a modification.

FIG. 12 is a circuit diagram illustrating an example configuration of a reference signal generator pertaining to another comparative example.

FIG. 13 is a timing waveform diagram illustrating an example of the operation of a reference signal generator according to another modification.

FIG. 14 is a circuit diagram illustrating an example configuration of a reference signal generator according to another modification.

FIG. 15 is an explanatory diagram illustrating one operating state of the reference signal generator illustrated in FIG. 14.

FIG. 16 is a circuit diagram illustrating an example configuration of the peripheral circuit of a comparison circuit according to another modification.

FIG. 17A is an explanatory diagram illustrating one example configuration of the attenuation circuit illustrated in FIG. 16.

FIG. 17B is another explanatory diagram illustrating an example configuration of the attenuation circuit illustrated in FIG. 16.

FIG. 18 is a circuit diagram illustrating an example configuration of a reference signal generator according to a reference example.

FIG. 19 is a timing waveform diagram illustrating an example of the operation of the reference signal generator illustrated in FIG. 18.

FIG. 20A is an explanatory diagram illustrating one operating state of the reference signal generator illustrated in FIG. 18.

FIG. 20B is another explanatory diagram illustrating one operating state of the reference signal generator illustrated in FIG. 18.

FIG. 20C is another explanatory diagram illustrating one operating state of the reference signal generator illustrated in FIG. 18.

FIG. 20D is another explanatory diagram illustrating one operating state of the reference signal generator illustrated in FIG. 18.

FIG. 20E is another explanatory diagram illustrating one operating state of the reference signal generator illustrated in FIG. 18.

FIG. 20F is another explanatory diagram illustrating one operating state of the reference signal generator illustrated in FIG. 18.

FIG. 20G is another explanatory diagram illustrating one operating state of the reference signal generator illustrated in FIG. 18.

FIG. 21 is a block diagram depicting an example of schematic configuration of a vehicle control system.

FIG. 22 is a diagram of assistance in explaining an example of installation positions of an outside-vehicle information detecting section and an imaging section.

FIG. 23 is a block diagram illustrating an example of the configuration of a distance measuring device to which the present technology is applied.

### MODES FOR CARRYING OUT THE INVENTION

An embodiment of the present disclosure will be described in detail below with reference to the accompanying drawings. The description will be given in the following order.

### 1. Embodiment

2. Reference examples
3. Examples of application to mobile object

### 1. Embodiment

### [Example Configuration]

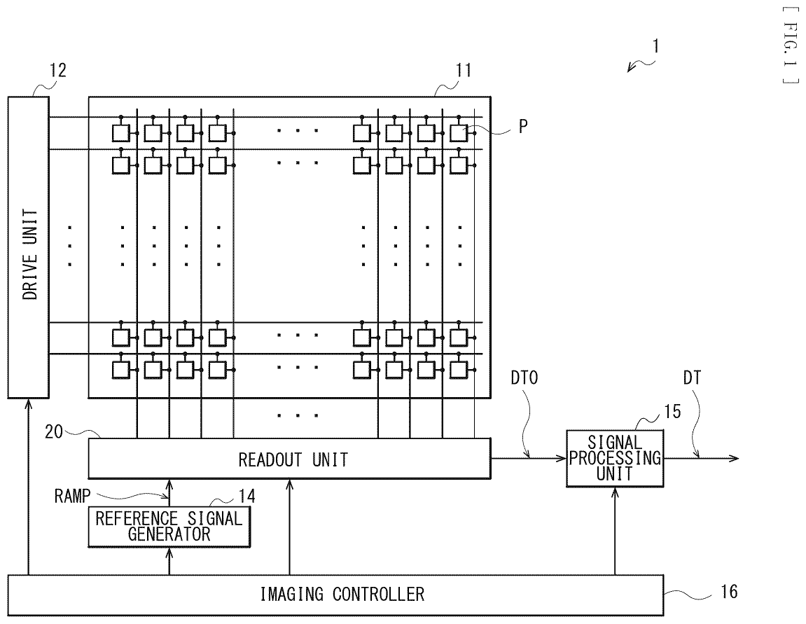

FIG. 1 illustrates an example configuration of an imaging device 1 to which a signal generation circuit according to one embodiment is applied. The imaging device 1 includes a pixel array 11, a drive unit 12, a readout unit 20, a reference signal generator 14, a signal processing unit 15, and an imaging controller 16.

The pixel array 11 has a plurality of photoreceptor pixels P disposed in a matrix. The photoreceptor pixels P are configured to generate a signal SIG including a pixel voltage Vpix according to the amount of received light.

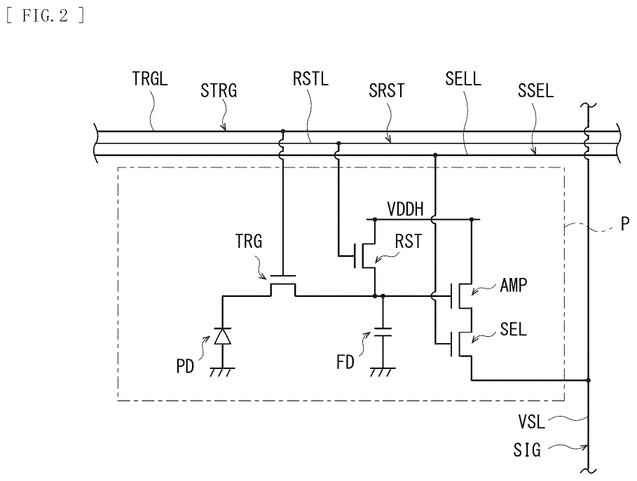

FIG. 2 illustrates an example configuration of a photoreceptor pixel P. The pixel array 11 includes a plurality of control lines TRGL, a plurality of control lines RSTL, a plurality of control lines SELL, and a plurality of signal lines VSL. The control lines TRGL extend horizontally (in the lateral direction in FIG. 2) and have one end coupled to the drive unit 12. A control signal STRG is supplied to the control lines TRGL from the drive unit 12. The control lines RSTL extend horizontally and have one end coupled to the drive unit 12. A control signal SRST is supplied to the control lines RSTL from the drive unit 12. The control lines SELL extend horizontally and have one end coupled to the drive unit 12. A control signal SSEL is supplied to the control lines SELL from the drive unit 12. The signal lines VSL extend vertically (in the longitudinal direction in FIG. 2) and have one end coupled to the readout unit 20. This signal lines VSL carry the signal SIG generated by the photoreceptor pixels P to the readout unit 20. A plurality of photoreceptor pixels P for one row disposed horizontally (in the lateral direction in FIGS. 1 and 2) constitute a pixel line L.

The photoreceptor pixel P includes a photodiode PD, a transistor TRG, a floating diffusion FD, and transistors RST, AMP, and SEL. The transistors TRG, RST, AMP, and SEL are N-type metal oxide semiconductor (MOS) transistors in this example.

The photodiode PD is a photoelectric conversion device that generates an amount of charge dependent on the amount of received light and accumulates the generated charge in it. The photodiode PD has an anode grounded and a cathode coupled to the source of the transistor TRG.

The transistor TRG has a gate coupled to the control line TRGL, a source coupled to the cathode of the photodiode PD, and a drain coupled to a floating diffusion FD.

The floating diffusion FD is configured to accumulate the charge transferred from the photodiode PD via the transistor TRG. The floating diffusion FD is configured, for example, with a diffusion layer formed on the surface of a semiconductor substrate. In FIG. 2, the floating diffusion FD is illustrated using the symbol of a capacitor.

The transistor RST has a gate coupled to the control line RSTL, a drain coupled to the power supply node of a power supply voltage VDDH, and a source coupled to the floating diffusion FD.

The transistor AMP has a gate coupled to the floating diffusion FD, a drain coupled to the power supply node of the power supply voltage VDDH, and a source coupled to the drain of the transistor SEL.

The transistor SEL has a gate coupled to the control line SELL, a drain coupled to the source of the transistor AMP, and a source coupled to the signal line VSL.

With this configuration, in the photoreceptor pixel P, the charge accumulated in the photodiode PD is discharged, for example, when the transistors TRG and RST go into the on state on the basis of the control signals STRG and SRST. When these transistors TRG and RST go into the off state, an exposure period T is started, and an amount of charge dependent on the amount of received light is accumulated in the photodiode PD. After the exposure period T ends, the photoreceptor pixel P outputs the signal SIG, including a reset voltage Vreset and a pixel voltage Vpix, to the signal line VSL. To be specific, first, the transistor SEL goes into the on state on the basis of the control signal SSEL, causing the photoreceptor pixel P to be electrically coupled to the signal line VSL. As a result, the transistor AMP is coupled to the constant current source 21 of the readout unit 20 (described below) and operates as a so-called source follower. As described below, in a P-phase (pre-charge phase) period TP starting after the voltage of the floating diffusion FD is reset when the transistor RST goes into the on state, the photoreceptor pixel P outputs a voltage dependent on the voltage of the floating diffusion FD at that time as the reset voltage Vreset. In a D-phase (Data-phase) period TD starting after the charge from the photodiode PD to the floating diffusion FD is transferred when the transistor TRG goes into the on state, the photoreceptor pixel P outputs a voltage dependent on the voltage of the floating diffusion FD at that time as the pixel voltage Vpix. The voltage difference between the pixel voltage Vpix and the reset voltage Vreset corresponds to the amount of received light at the photoreceptor pixel P in the exposure period T. In this way, the photoreceptor pixel P is designed to output the signal SIG including these reset voltage Vreset and pixel voltage Vpix to the signal line VSL.

The drive unit 12 (FIG. 1) is configured to sequentially drive a plurality of photoreceptor pixels P in the pixel array 11 on a pixel line L by pixel line L basis on the basis of an instruction from the imaging controller 16. To be specific, the drive unit 12 supplies a plurality of control signals STRG to a plurality of control lines TRGL in the pixel array 11, a plurality of control signals SRST to a plurality of control lines RSTL in the pixel array 11, and a plurality of control signals SSEL to a plurality of control lines SELL in the pixel array 11, thereby driving a plurality of photoreceptor pixels P in the pixel array 11 on a pixel line L by pixel line L basis.

The readout unit 20 is configured to generate image data DT0 by performing AD conversion on the basis of the signal SIG supplied from the pixel array 11 via the signal line VSL on the basis of an instruction from the imaging controller 16.

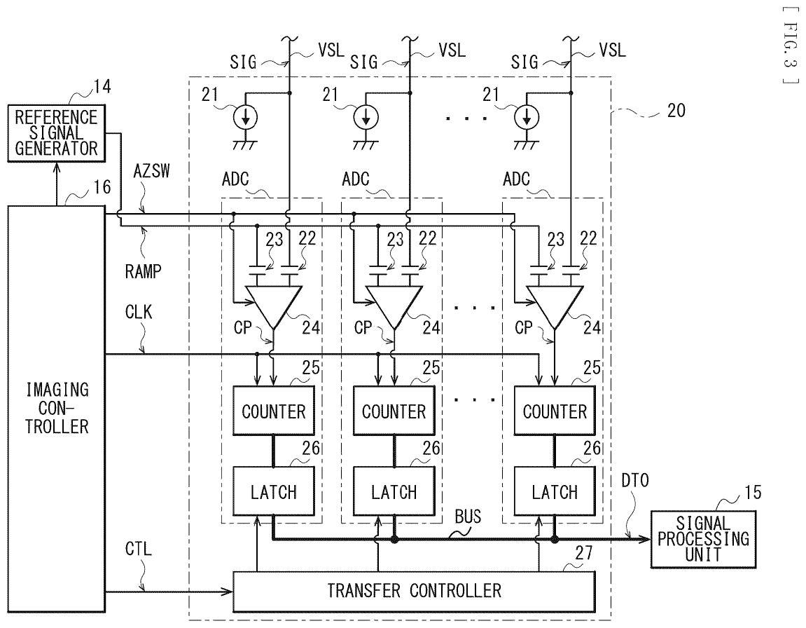

FIG. 3 illustrates an example configuration of the readout unit 20. Note that FIG. 3 depicts, besides the readout unit 20, the reference signal generator 14, signal processing unit 15, and imaging controller 16. The readout unit 20 includes a plurality of constant current sources 21, a plurality of analog to digital (AD) converters ADC, and a transfer controller 27. The plurality of constant current sources 21 and the plurality of AD converters ADC are respectively provided for the plurality of signal lines VSL. The constant current source 21 and AD converter ADC corresponding to a certain one signal line VSL will be described below.

The constant current source 21 is configured to flow a predetermined current to the corresponding signal line VSL. One end of the constant current source 21 is coupled to the corresponding signal line VSL, and another end is coupled to the ground node.

The AD converter ADC is configured to perform AD conversion on the basis of the signal SIG at the corresponding signal line VSL. The AD converter ADC includes capacitors 22 and 23, a comparison circuit 24, a counter 25, and a latch 26.

One end of the capacitor 22 is coupled to the signal line VSL and is supplied with the signal SIG, and another end is coupled to the comparison circuit 24. One end of the capacitor 23 is supplied with the reference signal RAMP supplied from the reference signal generator 14, and another end is coupled to the comparison circuit 24. The reference signal RAMP is a signal having a so-called ramp waveform whose voltage level gradually changes over time.

The comparison circuit 24 is configured to generate a signal CP by performing a comparison operation on the basis of the signal SIG supplied from the photoreceptor pixel P via the signal line VSL and the capacitor 22, and the reference signal RAMP supplied from the reference signal generator 14 via the capacitor 23. The comparison circuit 24 sets an operating point by setting the voltages of the capacitors 22 and 23 on the basis of a control signal AZSW supplied from the imaging controller 16. After that, the comparison circuit 24 performs a comparison operation to compare the reset voltage Vreset contained in the signal SIG with the voltage of the reference signal RAMP in the P-phase period TP, and a comparison operation to compare the pixel voltage Vpix contained in the signal SIG with the voltage of the reference signal RAMP in the D-phase period TD.

The counter 25 is configured to perform a counting operation to count the pulses of the clock signal CLK supplied from the imaging controller 16 on the basis of the signal CP supplied from the comparison circuit 24. To be specific, in the P-phase period TP, the counter 25 generates a count value CNTP by counting the pulses of the clock signal CLK until the signal CP transitions, and outputs this count value CNTP as a digital code having multiple bits. Further, in the D-phase period TD, the counter 25 generates a count value CNTD by counting the pulses of the clock signal CLK until the signal CP transitions, and outputs this count value CNTD as a digital code having multiple bits.

The latch 26 is configured to temporarily hold the digital code supplied from the counter 25 and output the digital code to bus wiring BUS on the basis of an instruction from the transfer controller 27.

The transfer controller 27 is configured to control the latches 26 of the plurality of AD converters ADC to make them sequentially output the digital codes to the bus wiring BUS on the basis of a control signal CTL supplied from the imaging controller 16. The readout unit 20 uses this bus wiring BUS to sequentially transfer the plurality of digital codes supplied from the plurality of AD converters ADCs to the signal processing unit 15 as image data DT0.

The reference signal generator 14 is configured to generate a reference signal RAMP on the basis of an instruction from the imaging controller 16. The reference signal RAMP has a so-called ramp waveform whose voltage level gradually changes over time during the two periods (P-phase period TP and D-phase period TD) in which the readout unit 20 performs AD conversion. The reference signal generator 14 supplies such a reference signal RAMP to the readout unit 20.

FIG. 4 illustrates an example configuration of the reference signal generator 14. The reference signal generator 14 includes a resistor R3, a transistor MP1, a bias circuit 31, switches SW4 and SW5, a capacitor C1, an operation amplifier circuit 32, switches SW6, SW7, and SW1, a capacitor C2, a resistor R1, a switch SW2, a resistor R2, a switch SW3, and a control signal generator 33.

One end of the resistor R3 is coupled to the power supply node of the power supply voltage VDD, and another end is coupled to the source of the transistor MP1. The transistor MP1 is a P-type MOS transistor and has a gate supplied with a bias voltage Vbias generated by a bias circuit 31, a source coupled to the other end of the resistor R3, and a drain coupled to switches SW4 and SW5. The bias circuit 31 is configured to generate the bias voltage Vbias. The resistor R3, the transistor MP1, and the bias circuit 31 constitute a constant current source.

One end of the switch SW4 is coupled to the drain of the transistor MP1 and the switch SW5, and another end is coupled to a node N1. The switch SW4 is configured to be turned on and off on the basis of a control signal S4. The switch SW5 is coupled to the drain of the transistor MP1 and the switch SW4, and another end is coupled to the ground node. The switch SW5 is configured to be turned on and off on the basis of a control signal S4B. The control signal S4B is the inverted signal of the control signal S4.

One end of the capacitor C1 is coupled to the node N1 and another end is coupled to a node N2. The operation amplifier circuit 32 has a positive input terminal coupled to the switches SW6 and SW7, a negative input terminal coupled to the node N2, and an output terminal coupled to the output terminal OUT of the reference signal generator 14. One end of the switch SW6 is coupled to the positive input terminal of the operation amplifier circuit 32, and another end is supplied with a voltage VREF1. The switch SW6 is configured to be turned on and off on the basis of a control signal S6. One end of the switch SW7 is coupled to the positive input terminal of the operation amplifier circuit 32, and another end is supplied with a voltage VREF2. The switch SW7 is configured to be turned on and off on the basis of a control signal S6B. The voltage VREF2 is higher than the voltage VREF1. The control signal S6B is the inverted signal of the control signal S6. One end of t the switch SW1 is coupled to the node N2 and another end is coupled to the output terminal OUT of the reference signal generator 14. This switch SW1 is configured to be turned on and off on the basis of the control signal S1. One end of the capacitor C2 is coupled to the node N1, and another end is coupled to the output terminal OUT of the reference signal generator 14. One end of the resistor R1 is coupled to the node N1, and another end is coupled to the switch SW2. One end of the switch SW2 is coupled to the other end of the resistor R1, and another end is grounded. The switch SW2 is configured to be turned on and off on the basis of the control signal S1. One end of the resistor R2 is coupled to the other end of the switch SW3, and another end is coupled to the output terminal OUT of the reference signal generator 14. One end of the switch SW3 is coupled to the node N1, and another end is coupled to the resistor R2. The switch SW3 is configured to be turned on and off on the basis of the control signal S1.

The control signal generator 33 is configured to generate control signals S1, S4, S4B, S6, and S6B on the basis of the control signals supplied from the imaging controller 16. The control signal generator 33 is designed to control the operation of the switches SW1 to SW3 using the control signal S1, control the operation of the switch SW4 using the control signal S4, control the operation of the switch SWS using the control signal S4B, control the operation of the switch SW6 using the control signal S6, and control the operation of the switch SW7 using the control signal S6B.

The signal processing unit 15 (FIG. 1) is configured to generate image data DT by performing predetermined image processing on the basis of the image data DT0 and an instruction from the imaging controller 16. The predetermined image processing includes, for example, correlated double sampling (CDS) processing. In the CDS processing, the signal processing unit 15 is designed to generate a pixel value VAL using the principle of correlated double sampling on the basis of the count value CNTP obtained in the P-phase period TP and the count value CNTD obtained in the D-phase period TD contained the image data DT0.

The imaging controller 16 is configured to supply control signals to the drive unit 12, the readout unit 20, the reference signal generator 14, and the signal processing unit 15, and control the operation of these circuits, thereby controlling the operation of the imaging device 1. To be specific, the imaging controller 16 supplies a control signal to the drive unit 12, thereby controlling the drive unit 12 to make it sequentially drive a plurality of photoreceptor pixels P in the pixel array 11 on a pixel line L by pixel line L basis. The imaging controller 16 also supplies a control signal to the reference signal generator 14, thereby controlling the reference signal generator 14 to make it generate the reference signal RAMP. The imaging controller 16 also supplies a control signal to the readout unit 20, thereby controlling the readout unit 20 to make it perform AD conversion on the basis of the signal SIG to generate the image data DT0.

The imaging controller 16 supplies a control signal to the signal processing unit 15, thereby controlling the operation of the signal processing unit 15.

Here, the resistor R3 and the transistor MP1 correspond to one specific example of a “constant current source” of one embodiment of the present disclosure. The operation amplifier circuit 32 corresponds to one specific example of an “operation amplifier circuit” of one embodiment of the present disclosure. The capacitor C1 corresponds to one specific example of a “first capacitor” of one embodiment of the present disclosure. The capacitor C2 corresponds to one specific example of a “second capacitor” of one embodiment of the present disclosure. The switch SW1 corresponds to one specific example of a “first switch” of one embodiment of the present disclosure. The resistor R1 corresponds to one specific example of a “first resistor” of one embodiment of the present disclosure. The switch SW2 corresponds to one specific example of a “second switch” of one embodiment of the present disclosure. The resistor R2 corresponds to one specific example of a “second resistor” of one embodiment of the present disclosure. The switch SW3 corresponds to one specific example of a “third switch” of one embodiment of the present disclosure. The switch SW4 corresponds to one specific example of a “fourth switch” of one embodiment of the present disclosure. The switch SW5 corresponds to one specific example of a “fifth switch” of one embodiment of the present disclosure. The switch SW6 corresponds to one specific example of a “sixth switch” of one embodiment of the present disclosure. The switch SW7 corresponds to one specific example of a “seventh switch” of one embodiment of the present disclosure. The control signal generator 33 corresponds to one specific example of a “controller” of one embodiment of the present disclosure. The photoreceptor pixel P corresponds to one specific example of a “photodetection circuit” of one embodiment of the present disclosure. The comparison circuit 24 corresponds to one specific example of a “comparison circuit” of one embodiment of the present disclosure.

### [Operation and Workings]

The operation and workings of the imaging device 1 of this embodiment will now be explained.

### (Summary of Overall Operation)

First, a summary of the overall operation of the imaging device 1 will be explained with reference to FIGS. 1 and 3. The drive unit 12 sequentially drives a plurality of photoreceptor pixels P in the pixel array 11 on a pixel line L by pixel line L basis on the basis of an instruction from the imaging controller 16. The reference signal generator 14 generates the reference signal RAMP on the basis of an instruction from the imaging controller 16. The photoreceptor pixel P outputs the reset voltage Vreset as a signal SIG in the P-phase period TP, and outputs the pixel voltage Vpix as a signal SIG in the D-phase period TD dependent on the amount of received light. The readout unit 20 generates image data DT0 on the basis of the signal SIG supplied from the pixel array 11 via the signal line VSL, the reference signal RAMP supplied from the reference signal generator 14, and an instruction from the imaging controller 16. To be specific, in the readout unit 20, the AD converter ADC generates a count value CNTP by performing AD conversion in the P-phase period TP on the basis of the signal SIG and the reference signal RAMP, and outputs this count value CNTP as a digital code baving multiple bits. The AD converter ADC also generates the count value CNTD by performing AD conversion in the D-phase period TD on the basis of the signal SIG and the reference signal RAMP, and outputs this count value CNTD as a digital code having multiple bits. The readout unit 20 supplies the plurality of digital codes including the count value CNTP and the plurality of digital codes including the count value CNTD generated by the plurality of AD converters ADC to the signal processing unit 15 as image data DT0 sequentially via the bus wiring BUS. The signal processing unit 15 generates image data DT by performing predetermined image processing on the basis of the image data DT0 and an instruction from the imaging controller 16.

### (Detailed Operation)

In the imaging device 1, a plurality of photoreceptor pixels P accumulates charge according to the amount of received light and generates the signal SIG including the pixel voltage Vpix according to the amount of received light. The readout unit 20 performs AD conversion on the basis of this signal SIG and the reference signal RAMP. This operation will be described in detail below.

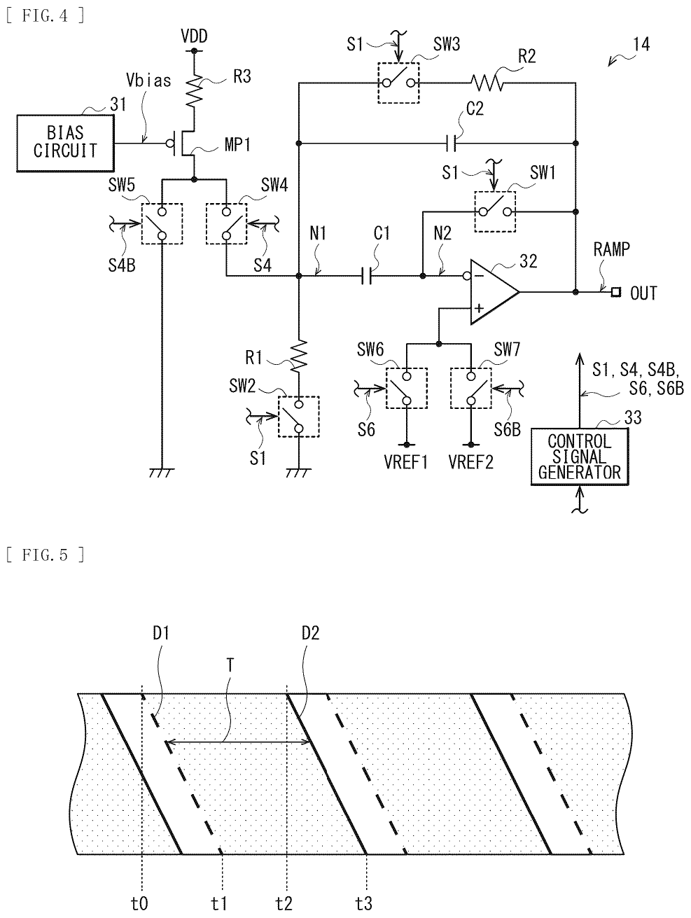

FIG. 5 illustrates an example of the operation of scanning a plurality of photoreceptor pixels P in the pixel array 11 on a pixel line L by pixel line L basis.

During the period from the time t0 to the time t1, the imaging device 1 performs exposure start driving DI for the pixel array 11 sequentially from the top in the vertical direction. To be specific, the drive unit 12 generates, for example, the control signals STRG and SRST to sequentially select the pixel lines L, and sequentially brings the transistors TRG and RST in the photoreceptor pixels P into the on state for a predetermined length of time. Consequently, in the photoreceptor pixels P, the voltage of the floating diffusion FD and the voltage of the cathode of the photodiode PD are set to the power supply voltage VDDH. When the transistors TRG and RST are in the off state, the photodiode PD begins to accumulate charge according to the amount of received light. In this way, the exposure period T starts sequentially in the plurality of photoreceptor pixels P.

Subsequently, the imaging device 1 performs readout driving D2 for the pixel array 11 during the period from the time T2 to the time T3, sequentially from the top in the vertical direction. To be specific, as described below, the drive unit 12 generates the control signals STRG, SRST, and SSEL to sequentially select the pixel lines L. Consequently, the photoreceptor pixels P output the reset voltage Vreset as the signal SIG during the P-phase period TP and outputs the pixel voltage Vpix as the signal SIG during the D-phase period TD. The readout unit 20 performs AD conversion on the basis of the signal SIG including the reset voltage Vreset and pixel voltage Vpix output by the photoreceptor pixels P.

The imaging device 1 repeats such exposure start driving DI and readout driving D2. As a result, the imaging device 1 obtains a series of captured images.

The readout driving D2 will now be explained in detail. The following focuses on a certain photoreceptor pixel P and explains the details of the operations of the photoreceptor pixel P and the AD converter ADC coupled to the photoreceptor pixel P.

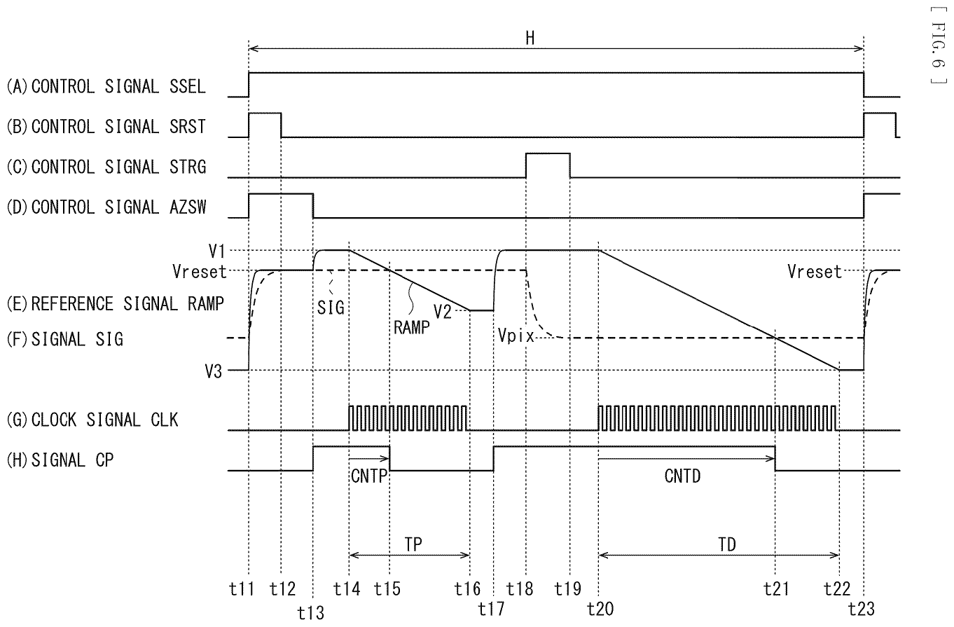

FIG. 6 illustrates an example of the operation of the readout driving D2: (A) illustrates the waveform of the control signal SSEL, (B) illustrates the waveform of the control signal SRST, (C) illustrates the waveform of the control signal STRG, (D) illustrates the waveform of the control signal AZSW, (E) illustrates the waveform of the reference signal RAMP, (F) illustrates the waveform of the signal SIG, (G) illustrates the waveform of the clock signal CLK, and (H) illustrates the waveform of the signal CP. In FIGS. 6(E) and 6(F), the waveforms of the reference signal RAMP and signal SIG are illustrated using the same voltage axis. In this explanation, the waveform of the reference signal RAMP illustrated in FIG. 6(E) is the waveform of the voltage supplied to the input terminal of the comparison circuit 24 via the capacitor 23, and the waveform of the signal SIG illustrated in FIG. 6(F) is the waveform of the voltage supplied to the input terminal of the comparison circuit 24 via the capacitor 22.

First, at the time t11, a horizontal period H starts. This causes the drive unit 12 to change the voltage of the control signal SSEL from low to high (FIG. 6(A)). As a result, in photoreceptor pixel P, the transistor SEL goes into the on state and the photoreceptor pixel P is electrically coupled to the signal line VSL. At this time t11, the drive unit 12 changes the voltage of the control signal SRST from low to high (FIG. 6(B)). As a result, in the photoreceptor pixel P, the transistor RST goes into the on state and the voltage of the floating diffusion FD is set to the power supply voltage VDDH(reset operation). The photoreceptor pixel P then outputs a voltage corresponding to the voltage of the floating diffusion FD at the time. At this time t11, the imaging controller 16 changes the voltage of the control signal AZSW from low to high (FIG. 6(D)). This causes the comparison circuit 24 of the AD converter ADC to set the voltages of the capacitors 22 and 23, thereby setting an operating point. In this way, the voltage of the signal SIG is set to the reset voltage Vreset, and the voltage of the reference signal RAMP is set to the same voltage as the signal SIG (reset voltage Vreset) (FIGS. 6(E) and 6(F)).

At the time t12, the drive unit 12 changes the voltage of the control signal SRST from high to low (FIG. 6(B)). Hence, in the photoreceptor pixel P, the transistor RST goes into the off state and the reset operation is completed.

Next, at the time t13, the imaging controller 16 changes the voltage of the control signal AZSW from high to low (FIG. 6(D)). This causes the comparison circuit 24 to terminate setting the operating point.

At the time t13, the reference signal generator 14 sets the voltage of the reference signal RAMP to a voltage V1 (FIG. 6(E)). As a result, the voltage of the reference signal RAMP becomes higher than the voltage of the signal SIG, causing the comparison circuit 24 to change the voltage of the signal CP from low to high (FIG. 6(H)).

Subsequently, during the period from the time t14 to the time t16 (P-phase period TP), the AD converter ADC performs AD conversion on the basis of the signal SIG. To be specific, first, at the time t14, the reference signal generator 14 starts to decrease the voltage of the reference signal RAMP from the voltage V1 at a predetermined rate of change (FIG. 6(E)). Further, at the time t14, the imaging controller 16 starts to generate the clock signal CLK (FIG. 6(G)). The counter 25 of the AD converter ADC performs a counting operation to count the pulses of this clock signal CLK.

At the time t15, the voltage of the reference signal RAMP falls below the voltage of the signal SIG(reset voltage Vreset) (FIGS. 6(E) and 6(F)). This causes the comparison circuit 24 of the AD converter ADC to change the voltage of the signal CP from high to low (FIG. 6(H)). The counter 25 of the AD converter ADC stops the counting operation on a basis of this signal CP transition. The count value of the counter 25 at this time(count value CNTP) is a value dependent on the reset voltage Vreset. The latch 26 holds this count value CNTP. The counter 25 then resets the count value.

Next, at the time t16, the imaging controller 16 stops generating the clock signal CLK as the P-phase period TP ends (FIG. 6(G)). The reference signal generator 14 also sets the voltage of the reference signal RAMP to the voltage V2 at the time t16 (FIG. 6(E)). During the period after the time t16, the readout unit 20 supplies the count value CNTP held in the latch 26 as the image data DT0 to the signal processing unit 15.

Next, at the time t17, the imaging controller 16 sets the voltage of the reference signal RAMP to the voltage V1 (FIG. 6(E)). Consequently, the voltage of the reference signal RAMP goes higher than the voltage of the signal SIG(reset voltage Vreset), causing the comparison circuit 24 to change the voltage of the signal CP from low to high (FIG. 6(H)).

Next, at the time t18, the drive unit 12 changes the voltage of the control signal STRG from low to high (FIG. 6(C)). As a result, in the photoreceptor pixel P, the transistor TRG goes into the on state and the charge generated in the photodiode PD is transferred to the floating diffusion FD (charge transfer operation). The photoreceptor pixel P then outputs a voltage corresponding to the voltage of the floating diffusion FD at this time. In this way, the voltage of the signal SIG becomes the pixel voltage Vpix (FIG. 6(F)).

Subsequently, at the time t19, the drive unit 12 changes the voltage of the control signal STRG from high to low (FIG. 6(C)). Hence, in the photoreceptor pixel P, the transistor TRG goes into the off state and the charge transfer operation ends.

After that, during the period from the time t20 to the time t22 (D-phase period TD), the AD converter ADC performs AD conversion on the basis of the signal SIG. To be specific, first, at the time t20, the reference signal generator 14 starts to decrease the voltage of the reference signal RAMP from the voltage V1 at a predetermined rate of change (FIG. 6(E)). Further, at the time t20, the imaging controller 16 starts to generate the clock signal CLK (FIG. 6(G)). The counter 25 of the AD converter ADC performs a counting operation to count the pulses of this clock signal CLK.

At the time t21, the voltage of the reference signal RAMP falls below the voltage of the signal SIG (pixel voltage Vpix) (FIGS. 6(E) and 6(F)). This causes the comparison circuit 24 of the AD converter ADC to change the voltage of the signal CP from high to low (FIG. 7(H)). The counter 25 of the AD converter ADC stops the counting operation on the basis of this signal CP transition. The count value(count value CNTD) of the counter 25 at this time is a value dependent on the pixel voltage Vpix. The latch 26 holds this count value CNTD. The counter 25 then resets the count value.

Next, at the time t22, the imaging controller 16 stops generating the clock signal CLK as the D-phase period TD ends (FIG. 6(G)). Further, at the time t22, the reference signal generator 14 sets the voltage of the reference signal RAMP to the voltage V3 (FIG. 6(E)). During the period after the time t22, the readout unit 20 supplies the count value CNTD held in the latch 26 as the image data DT0 to the signal processing unit 15.

Next, at the time t23, the drive unit 12 changes the voltage of the control signal SSEL from high to low (FIG. 6(A)). Consequently, in the photoreceptor pixel P, the transistor SEL goes into the off state, and the photoreceptor pixel P is electrically decoupled from the signal line VSL.

In this way, the readout unit 20 supplies the image data DT0 including the count values CNTP and CNTD to the signal processing unit 15. The signal processing unit 15 generates the pixel value VAL, for example, on the basis of the count values CNTP and CNTD contained in the image data DT0, using the principle of correlated double sampling. To be specific, the signal processing unit 15 generates the pixel value VAL, for example, by subtracting the count value CNTP from the count value CNTD. In this way, the signal processing unit 15 generates image data DT by performing predetermined processing.

### (Operation of Reference Signal Generator 14)

The reference signal generator 14 generates the reference signal RAMP illustrated in FIG. 6(E) on the basis of an instruction from the imaging controller 16. The operation of the reference signal generator 14 will be described in detail below.

FIG. 7 illustrates an example of the operation of the reference signal generator 14: (A) illustrates the waveform of the reference signal RAMP, (B) illustrates the waveform of the control signal S4, (C) illustrates the waveform of the control signal S4B, (D) illustrates the waveform of the control signal S1, (E) illustrates the waveform of the control signal S6, and (F) illustrates the waveform of the control signal S6B.

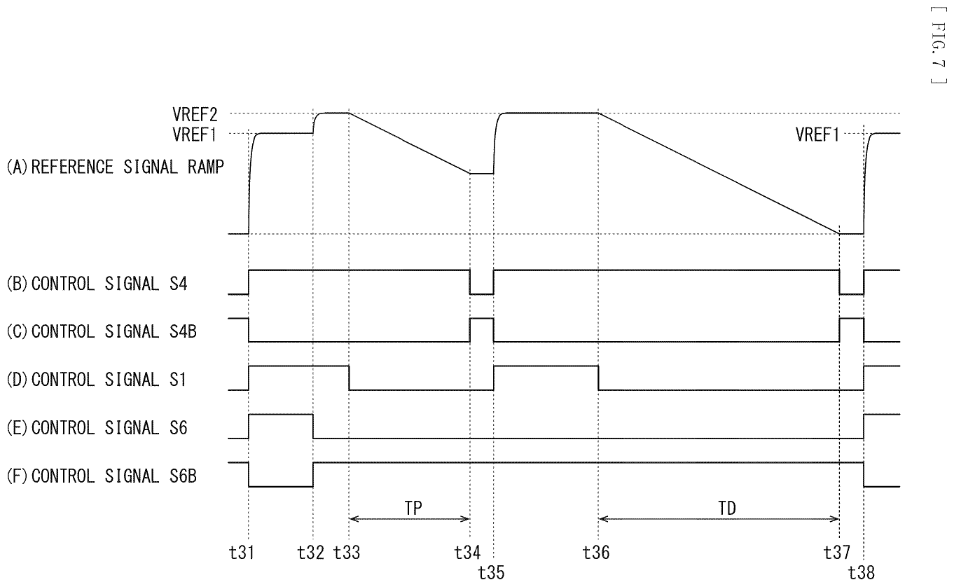

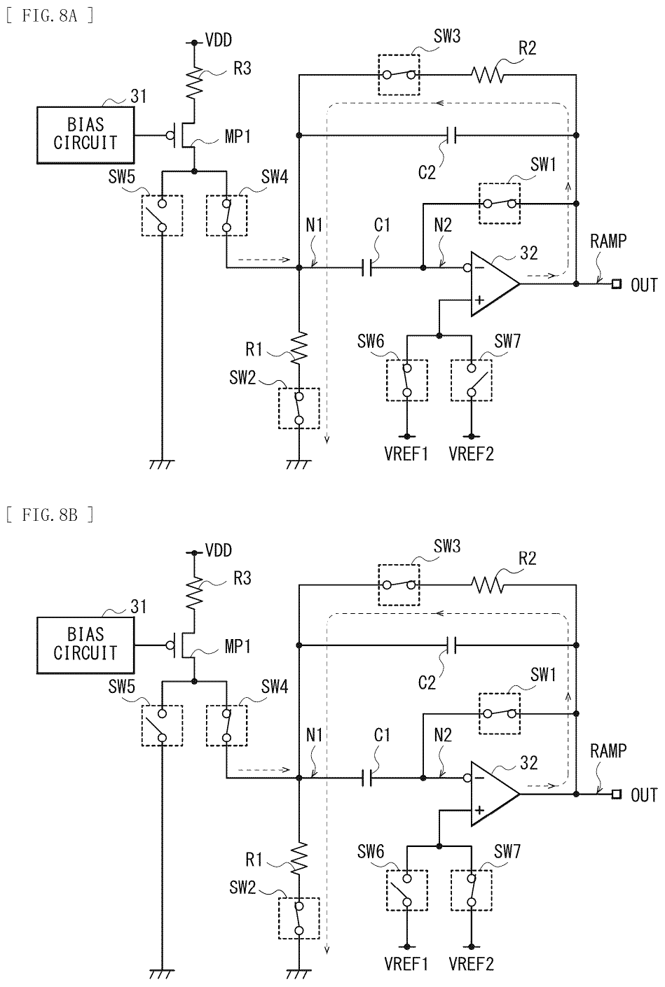

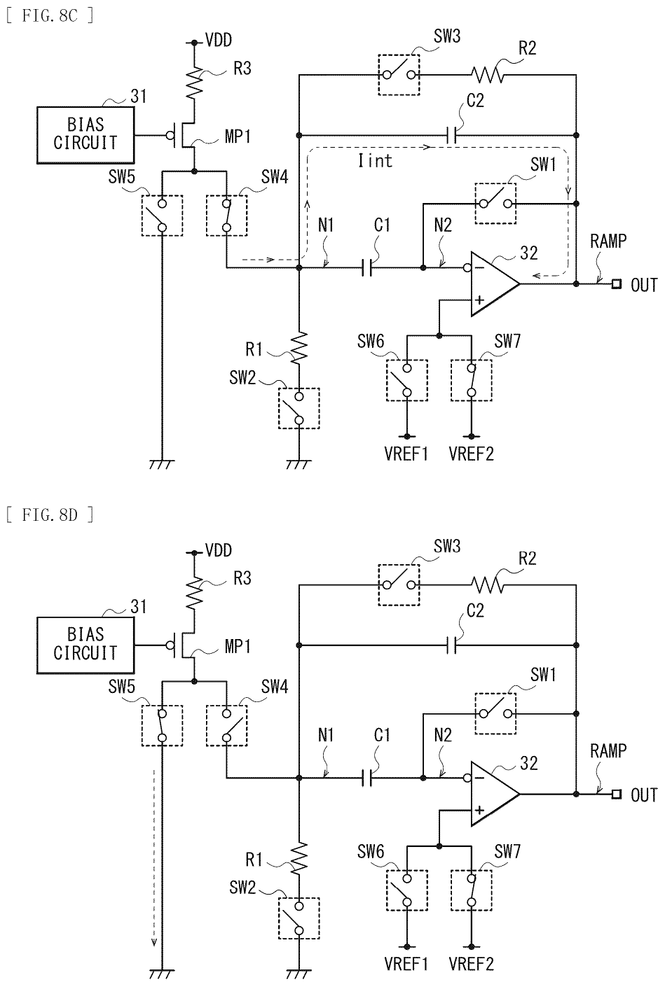

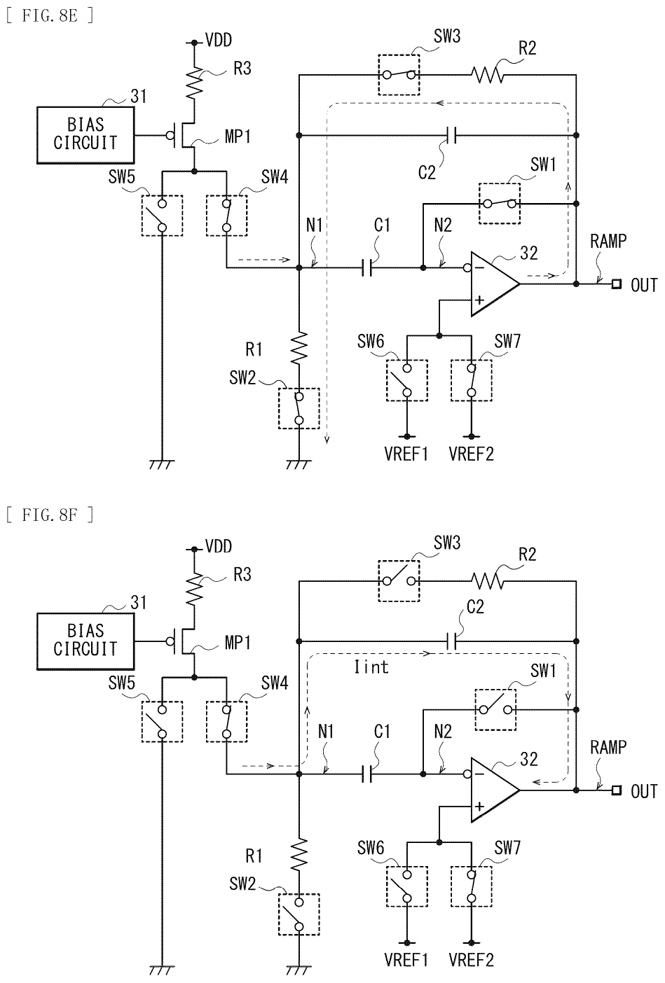

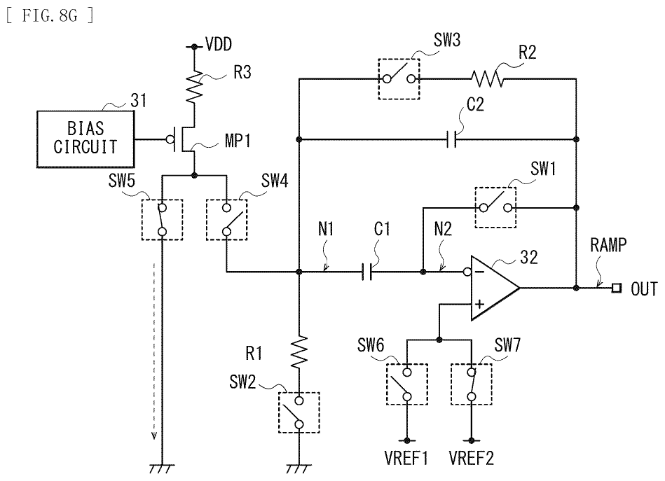

FIGS. 8A to 8G illustrate one operating state of the reference signal generator 14. In FIGS. 8A to 8G, the switches SW1 to SW7 are depicted with symbols representing the states of these switches.

First, at the time t31, the control signal generator 33 of the reference signal generator 14 changes the control signals S4, S1, and S6 from low to high, and also changes the control signals S4B and S6B from high to low (FIGS. 7(B) to 7(F)). Consequently, as illustrated in FIG. 8A, in the reference signal generator 14, the switches SW1 to SW4 and SW6 go into the on state and the switches SW5 and SW7 go into the off state.

Since the switch SW6 is in the on state, the voltage VREF1 is supplied to the positive input terminal of the operation amplifier circuit 32. Since the switch SW1 is in the on state, the negative input terminal of the operation amplifier circuit 32 and the output terminal of the operation amplifier circuit 32 are coupled. As a result, the operation amplifier circuit 32 operates as a so-called voltage follower. Thus, the voltage at the negative input terminal of the operation amplifier circuit 32 is the voltage VREF1, and the voltage at the output terminal of the operation amplifier circuit 32 is also the voltage VREF1. Since the switches SW2 and SW3 are in the on state, current flows from the output terminal of the operation amplifier circuit 32 to the resistor R2, the switch SW3, the resistor R1, and then the switch SW2. Further, since the switch SW4 is in the on state, current flows from the transistor MP1 to the node N1. The current value of the current flowing from the transistor MP1 to the node N1 is set to a current value sufficiently smaller than the current values of the currents flowing to the resistors R1 and R2. For this reason, the voltage of the node N1 is a voltage (r1/(r1+r2)×VREF1) obtained by dividing the voltage VREF1 at the output terminal of the operation amplifier circuit 32 by the resistors R1 and R2. Here, r1 is the resistance of the resistor R1, and r2 is the resistance of the resistor R2. The voltage at the node N1 is set to allow the transistor MP1 to operate in the saturation region. The voltage at the node N1 is set lower than the voltage at the node N2 (voltage VREF1). In this way, the reference signal generator 14 sets the voltage of the reference signal RAMP to the voltage VREF1 (FIG. 7(A)).

Next, at the time t32, the control signal generator 33 changes the control signal S6 from high to low and also changes the control signal S6B from low to high (FIGS. 7(E) and 7(F)). As a result, as illustrated in FIG. 8B, in the reference signal generator 14, the switch SW7 goes into the on state and the switch SW6 goes into the off state.

Since the switch SW7 is in the on state, the voltage VREF2 is supplied to the positive input terminal of the operation amplifier circuit 32. Since the operation amplifier circuit 32 operates as a voltage follower, the voltage at the node N2 changes from the voltage VREF1 to the voltage VREF2, and the voltage at the output terminal of the operation amplifier circuit 32 changes from the voltage VREF1 to the voltage VREF2.

Thus, the voltage at the node N1 is the voltage (r1/(r1+r2)×VREF2) obtained by dividing the voltage VREF2 at the output terminal of the operation amplifier circuit 32 by the resistors R1 and R2. This voltage at the node N1 is set to allow the transistor MP1 to operate in the saturation region. The voltage at the node N1 is set to a voltage lower than the voltage at the node N2 (voltage VREF2). In this way, the reference signal generator 14 changes the voltage of the reference signal RAMP from the voltage VREF1 to the voltage VREF2 (FIG. 7(A)).

Next, at the time t33, the control signal generator 33 changes the control signal S1 from high to low (FIG. 7(D)). Consequently, as illustrated in FIG. 8C, in the reference signal generator 14, the switches SW1 to SW3 go into the off state.

Since the switch SW1 is in the off state, the operating state of the voltage follower is canceled in the operation amplifier circuit 32. After that, the voltage difference between the two ends of the capacitor C1 is maintained. Since the voltage at the negative input terminal of the operation amplifier circuit 32 is maintained at the voltage VREF2, the voltage at the node N1 is also maintained. Since the switches SW2 and SW3 are in the off state, as illustrated in FIG. 8C, the current from the transistor MP1 flows into the output terminal of the operation amplifier circuit 32 via the capacitor C2 (current Iint). The capacitor C2 is gradually charged with this current Iint. In other words, the operation amplifier circuit 32 and the capacitors C1 and C2 constitute an integrating circuit. In this way, the reference signal generator 14 gradually decreases the voltage of the reference signal RAMP from the voltage VREF2 (FIG. 7(A)).

Next, at the time t34, the control signal generator 33 changes the control signal S4 from high to low and also changes the control signal S4B from low to high(FIGS. 7(B) and 7(C)). Accordingly, as illustrated in FIG. 8D, in the reference signal generator 14, the switch SW4 goes into the off state and the switch SW5 goes into the on state.

Since the switch SW4 is in the off state and the switch SW5 is in the on state, the current from the transistor MP1 flows to the ground node via the switch SW5. This stops the charging to the capacitor C2. In this way, the reference signal generator 14 stops changing the voltage of the reference signal RAMP and maintains this voltage (FIG. 7(A)).

Next, at the time t35, the control signal generator 33 changes the control signals S1 and S4 from low to high, and also changes the control signal S4B from high to low (FIGS. 7(B) to 7(D)). Accordingly, as illustrated in FIG. 8E, in the reference signal generator 14, the switches SW1 to SW4 go into the on state and the switch SW5 goes into the off state.

Since the switch SW1 is in the on state, the operation amplifier circuit 32 operates as a voltage follower. Hence, the voltage at the negative input terminal of the operation amplifier circuit 32 is the voltage VREF2, and the voltage at the output terminal of the operation amplifier circuit 32 is also the voltage VREF2. Since the switches SW2 and SW3 are in the on state, the voltage at the node N1 is the voltage(r1/(r1+r2)×VREF2) obtained by dividing the voltage VREF2 at the output terminal of the operation amplifier circuit 32 by the resistors R1 and R2. The voltage at the node N1 is set to a voltage lower than the voltage at the node N2(voltage VREF2). In this way, the reference signal generator 14 changes the voltage of the reference signal RAMP to the voltage VREF2 (FIG. 7(A)).

Next, at the time t36, the control signal generator 33 changes the control signal S1 from high to low (FIG. 7(D)). Consequently, as illustrated in FIG. 8F, in the reference signal generator 14, the switches SW1 to SW3 go into the off state.

Since the switch SW1 is in the off state, the operating state of the voltage follower is canceled in the operation amplifier circuit 32. After that, the voltage difference between the two ends of the capacitor C1 is maintained. Since the voltage at the negative input terminal of the operation amplifier circuit 32 is maintained at the voltage VREF2, the voltage at the node N1 is also maintained. Since the switches SW2 and SW3 are in the off state, as illustrated in FIG. 8F, the current from the transistor MP1 flows into the output terminal of the operation amplifier circuit 32 via the capacitor C2 (current Iint). The capacitor C2 is gradually charged with this current Iint. In this way, the reference signal generator 14 gradually decreases the voltage of the reference signal RAMP from the voltage VREF2 (FIG. 7(A)).

Next, at the time t37, the control signal generator 33 changes the control signal S4 from high to low and also changes the control signal S4B from low to high (FIGS. 7(B) and 7(C)). Accordingly, as illustrated in FIG. 8G, in the reference signal generator 14, the switch SW4 goes into the off state and the switch SW5 goes into the on state.

Since the switch SW4 is in the off state and the switch SW5 is in the on state, the current from the transistor MP1 flows to the ground node via the switch SW5. This stops the charging to the capacitor C2. In this way, the reference signal generator 14 stops change in the voltage of the reference signal RAMP and maintains this voltage (FIG. 7(A)).

The control signal generator 33 repeats this operation performed from the time t31 to the time t38 to generate the reference signal RAMP illustrated in FIG. 7(A).

In this way, the capacitor C1 and the switch SW1 are provided in the reference signal generator 14. This allows the voltage at the node N1 and the voltage at the node N2 to be set separately, thus widening the voltage range of the reference signal RAMP and increasing the dynamic range.

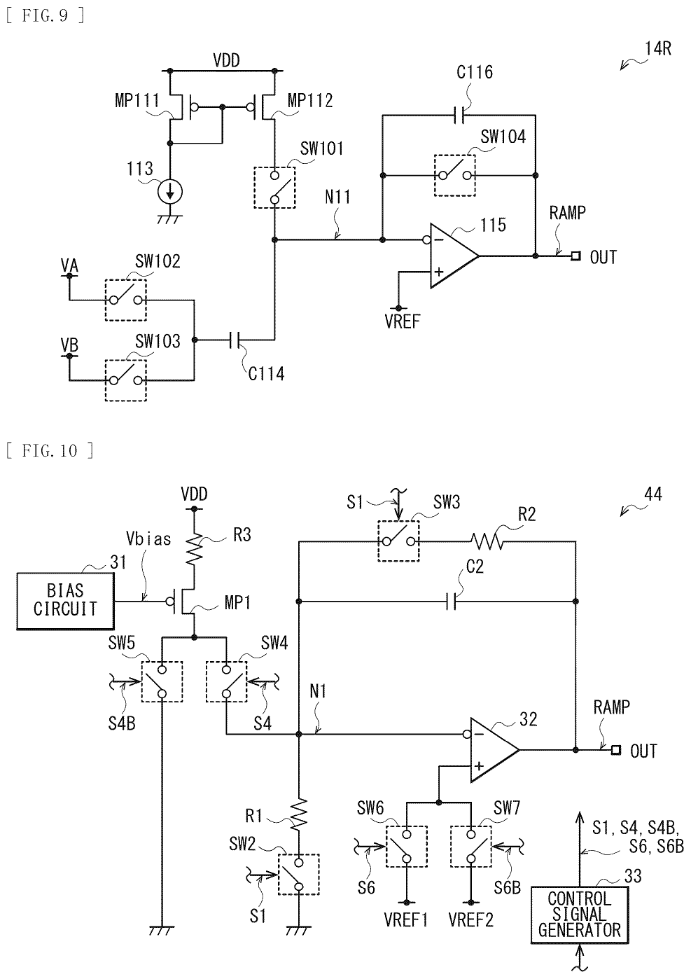

In other words, as illustrated in FIG. 9, for example, it is difficult to increase the dynamic range in the circuit described in PTL 1.

This reference signal generator 14R includes transistors MP111, MP112, a current source 113, switches SW101 to SW103, a capacitor C114, an operation amplifier circuit 115, a switch SW104, and a capacitor C116. The transistors MP111 and MP112 are P-type MOS transistors. The transistor MP111 has a gate coupled to the drain the of transistor MP111, the gate of the transistor MP112, and the current source 113, a source coupled to the power supply node of the power supply voltage VDD, and a drain coupled to the gates of the transistors MP111 and MP112 and the current source 113. One end of the current source 113 is coupled to the gates of the transistors MP111 and MP112 and the drain of the transistor MP111, and another end is coupled to the ground node. The transistor MP112 has a gate coupled to the gate of the transistor MP111, the drain of the transistor MP111, and the current source 113, a source coupled to the power supply node of the power supply voltage VDD, and a drain coupled to the switch SW101. One end of the switch SW101 is coupled to the drain of the transistor MP112, and another end is coupled to the node N11. One end of the switch SW102 is supplied with voltage VA, and another end is coupled to the switch SW103 and the capacitor C114. One end of the switch SW103 is supplied with voltage VB, and another end is coupled to the switch SW102 and the capacitor C114. One end of the capacitor C114 is coupled to the other end of the switch SW102 and the other end of the switch SW103, and another end is coupled to the node N11. The operation amplifier circuit 115 has a positive input terminal supplied with the voltage VREF, a negative input terminal coupled to the node N11, and an output terminal coupled to the output terminal OUT of the reference signal generator 14R. One end of the switch SW104 is coupled to the node N11, and another end is coupled to the output terminal OUT of the reference signal generator 14R. One end of the capacitor C116 is coupled to the node N11, and another end is coupled to the output terminal OUT of the reference signal generator 14R.

In this reference signal generator 14R, when the switch SW101 goes into the on state, the current Iint flows from the transistor MP112 to the output terminal of the operation amplifier circuit 115 via the switch SW101 and the capacitor C116. This causes the voltage of the reference signal RAMP to gradually decrease from the voltage VREF, as in the period from the time t33 to the time t34 and the period from the time t36 to the time t37 in FIG. 7. Further, the switches SW102 and SW103 are switched to change the voltage of the reference signal RAMP as at the times t31, t32, and t35 in FIG. 7.

Thus, in the reference signal generator 14R, bringing the switch SW101 into the on state causes the reference signal RAMP to gradually decrease from the voltage VREF. At this time, the voltage at the negative input terminal of the operation amplifier circuit 115 is the voltage VREF. For the transistor MP112 to operate in the saturation region, it is difficult to increase this voltage VREF. Since the reference signal RAMP gradually decreases from this voltage VREF, it is difficult to widen the voltage range of the reference signal RAMP in this reference signal generator 14R.

Meanwhile, the reference signal generator 14 is provided with the capacitor C1 and the switch SW1. This allows during the time t31 to t32, for example, the voltage of the node N2 to be set to the voltage VREF2 and the voltage of the node N1 to be the voltage(r1/(r1+r2)×VREF2) which is obtained by dividing the voltage VREF2 by the resistors R1 and R2. The reference signal RAMP gradually decreases from this voltage VREF2. Since the voltage of the node N1 is lower than this voltage VREF2, it is possible to operate the transistor MP1 in the saturation region while the voltage VREF2 is made high. Thus, in the reference signal generator 14, it is possible to widen the voltage range of the reference signal RAMP and increase the dynamic range.

Moreover, in this way, in the reference signal generator 14, it is possible to lower the voltage of the node N1, thereby allowing the resistor R3 to be disposed between the source of the transistor MP1 and the power supply node of the power supply voltage VDD. This so-called source degeneration makes it possible to reduce the noise of the current Iint in the reference signal generator 14. To be specific, for example, in a case where the resistor R3 is not disposed, it is possible to express the noise of the current Iint by the following equation.

In²=4kTγgₘ

Here, k is Boltzmann's constant, T is temperature, and gₘ is the transconductance of this transistor MP1. In a case where the resistor R3 is disposed, it is possible to express the noise of the current Iint by the following equation.

In²=4kTγ/R_{DG}

Here, R_{DG} is the resistance of this resistor R3. In the reference signal generator 14, it is possible to reduce the noise of the current Iint by increasing the resistance R_{DG} of this resistor R3. This allows the voltage noise in the reference signal RAMP to be reduced, resulting in an increase in the conversion accuracy of the AD conversion operation in the imaging device 1.

Note that another method of reducing noise could be, for example, to increase the capacitance of the capacitor C2. In this case, however, the circuit area becomes large. In the reference signal generator 14, in which the resistor R3 is provided to reduce noise by so-called source degeneration, it is possible to reduce noise without increasing the circuit area.

If, in the reference signal generator 14R illustrated in FIG. 9, a resistor is disposed between the source of the transistor MP112 and the power supply node of the power supply voltage VDD to reduce noise, the voltage VREF needs to be lowered to allow the transistor MP112 to operate in the saturation region. In this case, the voltage range of the reference signal RAMP becomes narrow. Besides, for example, in a case where the capacitances of the capacitors C114 and C116 are increased in this reference signal generator 14R to reduce noise, the circuit area becomes large. On the contrary, in the reference signal generator 14 according to this embodiment in which it is possible to set the voltage at the node N1 and the voltage at the node N2 separately, the resistor R3 is provided between the source of the transistor MP1 and the power supply node of the power supply voltage VDD to make it possible to increase the voltage VREF2 while lowering the voltage at the node N1. Hence, in the reference signal generator 14, it is possible to reduce voltage noise in the reference signal RAMP without increasing the circuit area while widening the voltage range of the reference signal RAMP. This results in an increase in the conversion accuracy of the AD conversion operation in the imaging device 1.

In the reference signal generator 14, the operation amplifier circuit 32 operates as a voltage follower, for example, during the period from the time t31 to the time t33 and the period from the time t35 to the time t36. Consequently, in the reference signal generator 14, it is possible to shorten the settling time when changing the voltage of the reference signal RAMP, for example, at the times t31, t32, and t35.

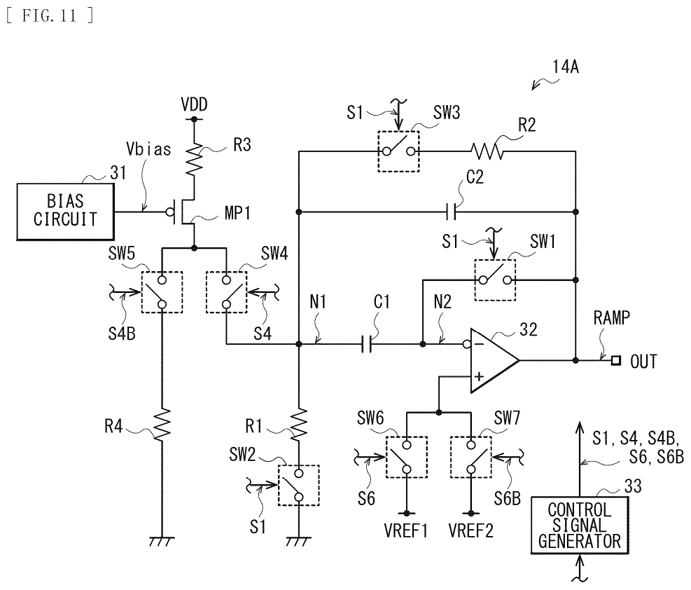

In other words, for example, in a case where the switch SW1 and the capacitor C1 are omitted from the reference signal generator 14 as in the reference signal generator 44 illustrated in FIG. 10, as explained in the reference example below, when the reference signal RAMP is set to a high voltage, the settling time becomes long due to the time constant dependent on the resistance of the resistor R2 and the capacitance of the capacitor C2.

On the contrary, in the reference signal generator 14 according to this embodiment in which the operation amplifier circuit 32 operates as a voltage follower, it is possible to change the voltage of the reference signal RAMP in a short time independently of the time constant of the resistor R2 and the capacitor C2. This allows the settling time to be shortened in the reference signal generator 14.

In the reference signal generator 14, the operation amplifier circuit 32 operates as a voltage follower, for example, during the period from the time t32 to the time t33 and the period from the time t35 to the time t36, which results in a reduction in the voltage noise in the reference signal RAMP. In other words, since the operation amplifier circuit 32 operates as a voltage follower, noise Vₙₒ, which is obtained by multiplying the input conversion noise Vₙᵢ of the operation amplifier circuit 32 by the gain of the voltage follower (1×) as in the following equation, appears in the reference signal RAMP.

Vₙₒ=Vₙᵢ×1

In this way, it is possible to reduce the voltage noise in the reference signal RAMP, for example, during the period from the time t32 to the time t33 and the period from the time t35 to the time t36. As illustrated in FIG. 7, in a case where the reference signal RAMP contains significant noise, for example, during the period from the time t32 to the time t33, the voltage of the reference signal RAMP starts to change from the voltage level containing this noise at the time t33. For this reason, in the imaging device 1, the conversion accuracy of the AD conversion operation may decrease. Similarly, in a case where the reference signal RAMP contains significant noise, for example, during the period from the time t35 to the time t36, the voltage of the reference signal RAMP starts to change from the voltage level containing this noise at the time t36. For this reason, in the imaging device 1, the conversion accuracy of the AD conversion operation may decrease. In the reference signal generator 14, it is possible to reduce the noise of the reference signal RAMP, for example, during the period from the time t32 to the time t33 and the period from the time t35 to the time t36, thereby increasing the accuracy of the AD conversion operation.

For example, in the reference signal generator 44 illustrated in FIG. 10, the feedback gain during the period when the switches SW2 and SW3 are in the on state is “r1/(r1+r2)”. Therefore, the noise Vₙₒ, which is obtained by multiplying the input conversion noise Vₙᵢ of the operation amplifier circuit 32 by the gain corresponding to the reciprocal of this feedback gain as in the following equation, appears in the reference signal RAMP.

Vₙₒ=Vₙᵢ×(r1+r2)/r1

Thus, in a case where the noise of the reference signal RAMP is significant, the conversion accuracy of the AD conversion operation may decrease. In the reference signal generator 14 according to this embodiment, it is possible to reduce the noise of the reference signal RAMP. This results in an increase in the conversion accuracy of the AD conversion operation in the imaging device 1.

Further, in the reference signal generator 14, the switches SW4 and SW5 are provided and bringing one of the switches SW4 and SWS into the on state causes the current from the transistor MP1 to flow to the node N1 or the ground node. Hence, in the reference signal generator 14, it is possible to keep the current flowing to the transistor MP1, thereby allowing a desired current to flow from the transistor MP1 to the node N1, for example, immediately after the switch SW4 goes into the on state.

In other words, for example, in the reference signal generator 14R illustrated in FIG. 9, the desired current may not flow from the transistor MP112 immediately after the switch SW101 goes into the on state. In this case, the voltage of the reference signal RAMP does not start to decrease immediately after the switch SW101 goes into the on state, which may decrease the accuracy of the AD conversion operation. In the reference signal generator 14 according to this embodiment, bringing one of the switches SW4 and SW5 into the on state causes the current from the transistor MP1 to flow to the node N1 or the ground node. Thus, in the reference signal generator 14, it is possible to make the desired current flow from the transistor MP1 to the node N1, for example, immediately after the switch SW4 goes into the on state. This results in an increase in the accuracy of the AD conversion operation in the imaging device 1.

As illustrated in FIG. 4, in the reference signal generator 14, the other end of the switch SW5 is coupled to the ground node; however, this is not necessarily the case. Alternatively, for example, a resistor R4 may be disposed in the path connecting the other end of the switch SW5 and the ground node, as in the reference signal generator 14A illustrated in FIG. 11. Note that this is not necessarily the case, which means, alternatively, for example, a diode may be disposed in the path connecting the other end of the switch SWS and the ground node. This makes it possible to bring the drain voltage of the transistor MP1 obtained when the switch SW4 is in the on state and the drain voltage of the transistor MP1 obtained when the switch SW5 is in the on state close to each other; thus, a simple configuration allows a desired current to flow from the transistor MP1 to the node N1 immediately after the switch SW4 goes into the on state.

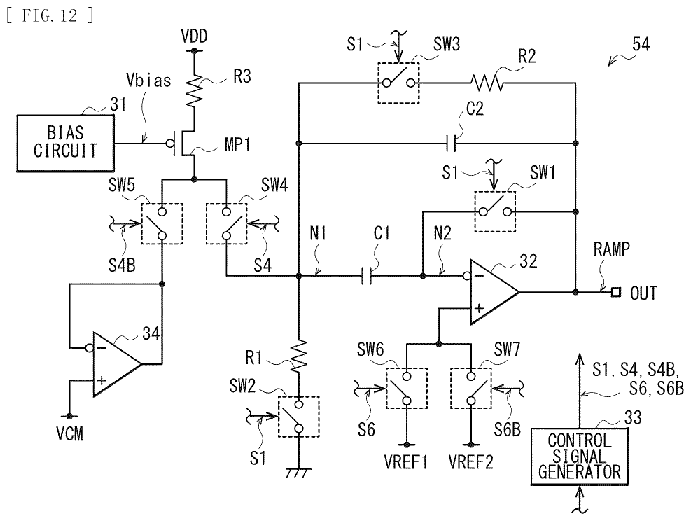

In other words, for example, in a case where an amplifier 34 for maintaining the drain voltage of the transistor MP1 is provided at the other end of the switch SW5 as illustrated in FIG. 12, the circuit area increases for the amplifier 34 and the power consumption increases for this amplifier 34. On the contrary, in the reference signal generator 14A illustrated in FIG. 11, it is possible to maintain the drain voltage of the transistor MP1 with a simple configuration, thereby causing a desired current to flow from the transistor MP1 to the node N1, for example, immediately after the switch SW4 goes into the on state while suppressing the circuit area and power consumption. This results in an increase in the accuracy of the AD conversion operation in the imaging device 1.

In addition, for the reference signal generator 14 according to this embodiment, for example, in a case where the circuit is redesigned for manufacturing by a finer semiconductor manufacturing process, it is possible to facilitate redesign work as described below.

For example, in the reference signal generator 14, it is possible to set the voltage at the node N1 and the voltage at the node N2 separately. Thus, for example, even in a case where a semiconductor manufacturing process with a lower power supply voltage is employed, it is possible to facilitate design to widen the voltage range of the reference signal RAMP while the transistor MP1 operates in the saturation region. On the contrary, for example, in the reference signal generator 14R illustrated in FIG. 9, it is necessary to design to make the voltage range of the reference signal RAMP as wide as possible within the range where the transistor MP112 operates in the saturation region.

For example, in the reference signal generator 14, it is possible to design to reduce the noise of the reference signal RAMP while suppressing the circuit area by adjusting the resistance of the resistor R3. On the contrary, for example, in the reference signal generator 14R illustrated in FIG. 9, it is not possible to dispose a resistor between the transistor MP112 and the power supply node of the power supply voltage VDD; thus, a method in which the capacitor C116 is increased is adopted. In this case, it is necessary to make the design while paying attention to the circuit area. Besides, in order to reduce noise, it is also necessary to take measures such as increasing the current of the operation amplifier circuit 115. In this case, it is necessary to make the design while paying attention to power consumption.

Thus, the reference signal generator 14 includes a current source(transistor MP1 and resistor R3) that is configured to flow a current from the power supply node of a power supply voltage to a first node (node N1), a first capacitor (capacitor C1) having one end coupled to the first node (node N1) and another end coupled to the second node (node N2), an operation amplifier circuit 32 having a positive input terminal, a negative input terminal coupled to a second node (node N2), and an output terminal coupled to an output node, a first switch (switch SW1) having one end coupled to the second node(node N2) and another end coupled to an output node, a second capacitor (capacitor C2) having one end coupled to the first node (node N1) and another end coupled to an output node, a first resistor (resistor R1) provided in a first path connecting the first node (node N1) and the ground node, and a second switch (switch SW2) that allows the first path to be turned on and off. Hence, in the reference signal generator 14, it is possible to set the voltage at the node N1 and the voltage at the node N2 separately, thereby widening the voltage range of the reference signal RAMP and increasing the dynamic range.

### [Effects]

As described above, in this embodiment, provided are a current source that is configured to flow current from the power supply node of a power supply voltage to a first node, a first capacitor having one end coupled to the first node and another end coupled to the second node, an operation amplifier circuit 32 having a positive input terminal, a negative input terminal coupled to a second node, and an output terminal coupled to an output node, a first switch having one end coupled to the second node and another end coupled to an output node, a second capacitor having one end coupled to the first node and another end coupled to an output node, a first resistor provided in a first path connecting the first node and the ground node, and a second switch that is configured to turn on and off the first path. This allows the voltage range of the reference signal to be widened and the dynamic range to be increased.

### [Modification 1-1]

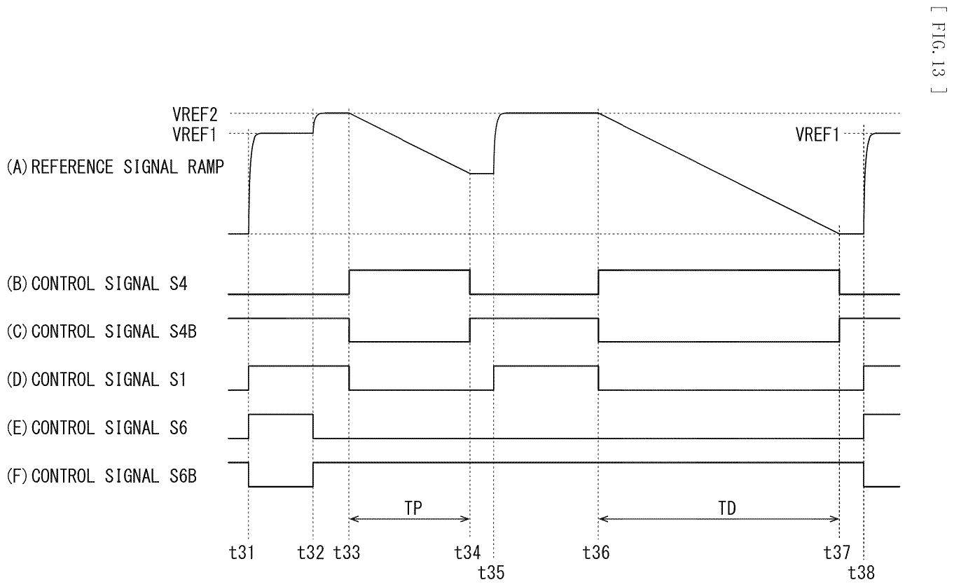

In the aforementioned embodiment, as illustrated in FIG. 7, the switch SW4 is brought into the on state during the period from the time t31 to the time t34 and the period from the time t35 to the time t37, and the switch SW5 is brought into the off state during these periods; however, this is not necessarily the case. Alternatively, for example, as illustrated in FIG. 13, the switch SW4 may be brought into the on state during the period from the t33 to the time t34 and the period from the time t36 to the time t37, and the switch SW5 may be brought into the off state during these periods.

### [Modification 1-2]

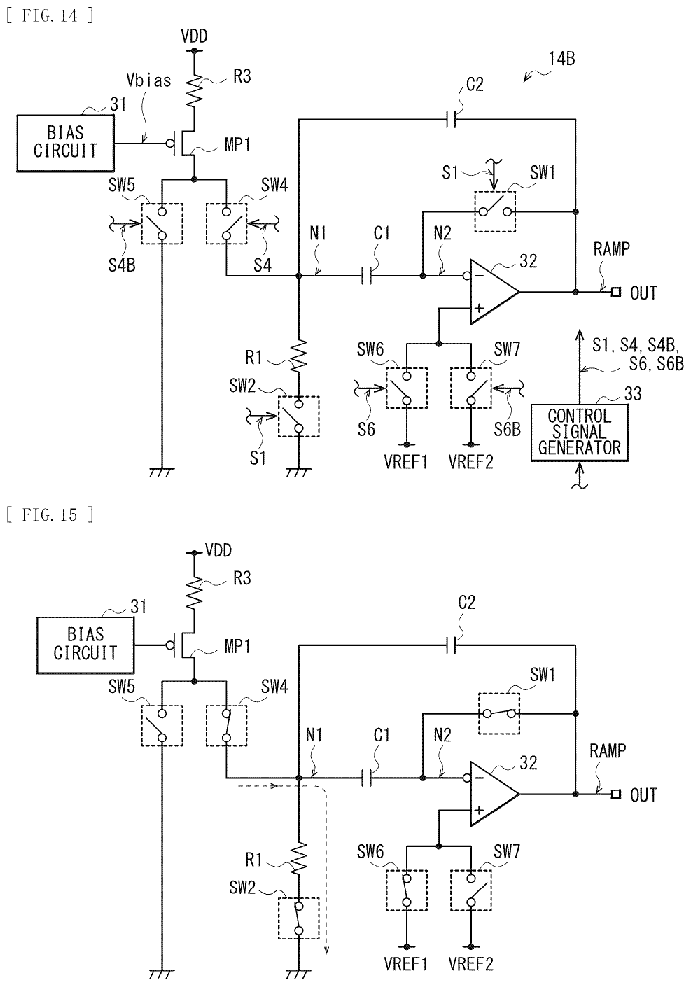

In the aforementioned embodiment, the resistor R2 and the switch SW3 are provided as illustrated in FIG. 4; however, this is not necessarily the case. Alternatively, for example, the resistor R2 and the switch SW3 may not be provided as in the reference signal generator 14B illustrated in FIG. 14. In this case, for example, during the period from the time t31 to the time t32, the voltage of the node N1 is set when current from the transistor MP1 flows through the resistor R1 as illustrated in FIG. 15. The same is true in the period from the time t32 to the time t33 and the period from the time t35 to the time 136.

### [Modification 1-3]

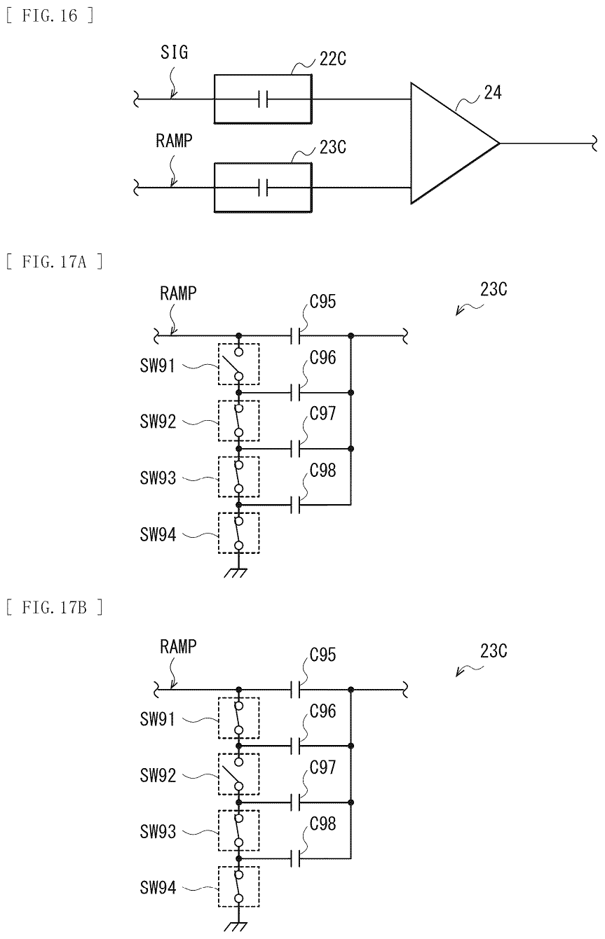

In the aforementioned embodiment, in the readout unit 20, the signal SIG is supplied to the comparison circuit 24 via the capacitor 22 and the reference signal RAMP is supplied via the capacitor 23. For example, in a case where the amplitude of the reference signal RAMP or the signal SIG is sufficiently large, the signal SIG and the reference signal RAMP may be supplied to the comparison circuit 24, for example, via the attenuation circuits 22C and 23C in which capacitors are used, illustrated in FIG. 16.

FIGS. 17A and 17B illustrate an example of the configuration of an attenuation circuit 23C. The attenuation circuit 23C includes switches SW91 to SW94 and capacitors C95 to C98. One end of the switch SW91 is supplied with a reference signal RAMP, and another end is coupled to the switch SW92 and the capacitor C96. One end of the switch SW92 is coupled to the other end of the switch SW91 and the capacitor C96, and another end is coupled to the switch SW93 and the capacitor C97. One end of the switch SW93 is coupled to the other end of the switch SW92 and the capacitor C97, and another end is coupled to the switch SW94 and the capacitor C98. One end of the switch SW94 is coupled to the other end of the switch SW93 and the capacitor C98, and another end is coupled to the ground node. One end of the capacitor C95 is supplied with the reference signal RAMP, and another end is coupled to the capacitors C96 to C98 and to the comparison circuit 24 (not shown in the drawings) disposed in the following stage. One end of the capacitor C96 is coupled to the other end of the switch SW91 and the one end of the switch SW92, and another end is coupled to the capacitors C95, C97, and C98, as well as to the comparison circuit 24(not shown in the drawings) disposed in the following stage. One end of the capacitor C97 is coupled to the other end of the switch SW92 and the one end of the switch SW93, and another end is coupled to the capacitors C95, C96, and C98 and to the comparison circuit 24 (not shown in the drawings) disposed in the following stage. One end of the capacitor C98 is coupled to the other end of the switch SW93 and the one end of the switch SW94, and another end is coupled to the capacitors C95 to C97 and to the comparison circuit 24 (not shown in the drawings) disposed in the following stage.

In FIG. 17A, the switch SW91 is in the off state and the switches SW92 to SW94 are in the on state. Hence, in the attenuation circuit 23C, the capacitors C96 to C98 are connected in parallel. The attenuation circuit 23C allows the reference signal RAMP to be attenuated by performing capacitive voltage division using the capacitor C95 and the capacitors C96 to C98.

Further, in FIG. 17B, the switches SW91, SW93, and SW94 are in the on state and the switch SW92 is in the off state. Hence, in the attenuation circuit 23C, the capacitors C95 and C96 are connected in parallel, and the capacitors C97 and C98 are connected in parallel. The attenuation circuit 23C allows the reference signal RAMP to be attenuated by performing capacitive voltage division using the capacitors C95 and C96 and the capacitors C97 and C98.

### [Modification 1-4]

In the aforementioned embodiment, AD conversion operation is performed on the basis of the signal SIG supplied from one column of photoreceptor pixels P; however, this is not necessarily the case. Alternatively, AD conversion operation may be performed, for example, at each of the photoreceptor pixels P.

### [Another Modification]

Two or more of these modifications may be used in combination.

### 2. Reference Example

Next, the reference signal generator 44 according to a reference example will be described. This reference example differs from the reference signal generator 14 according to the aforementioned embodiment in the method of widening the voltage range of the reference signal RAMP. Note that a component that is substantially the same as the corresponding one in the reference signal generator 14 according to the aforementioned embodiment is denoted by the same reference numeral as the corresponding one and its description will be omitted as appropriate.

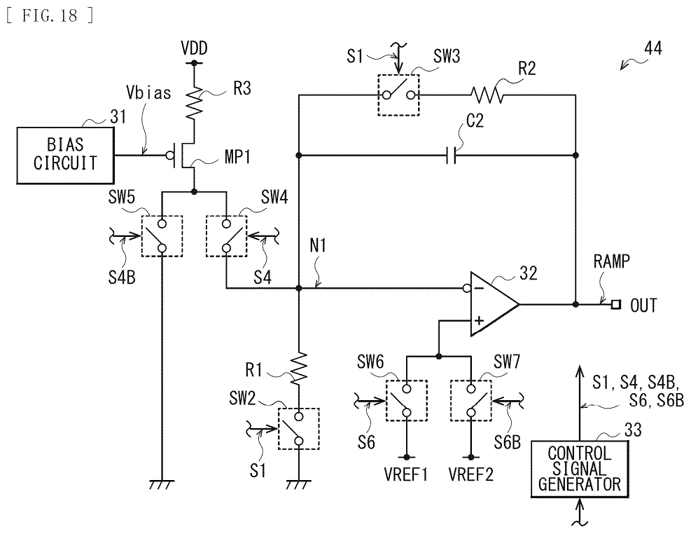

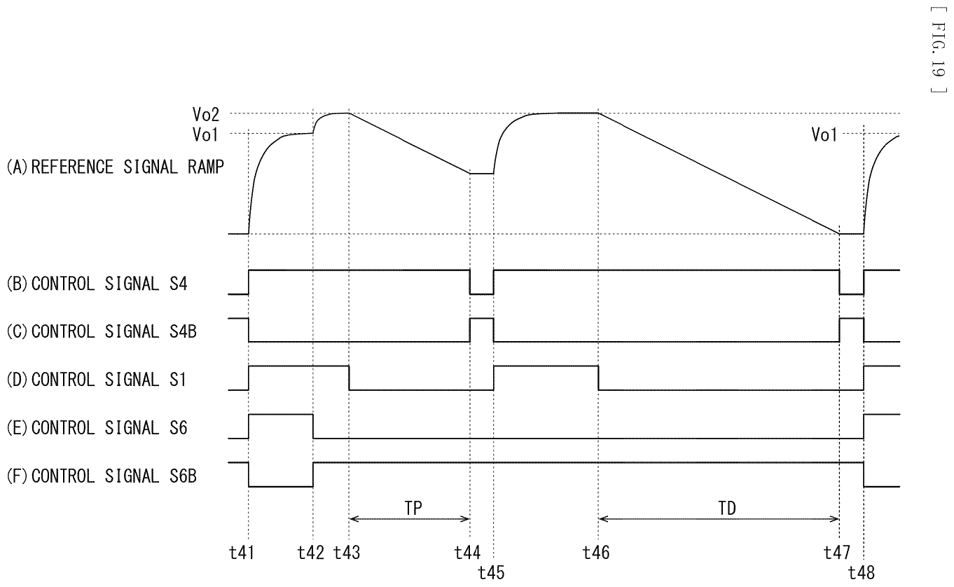

FIG. 18 illustrates an example of the configuration of the reference signal generator 44 according to the reference example. The reference signal generator 44 includes a resistor R3, a transistor MP1, a bias circuit 31, switches SW4 and SW5, an operation amplifier circuit 32, switches SW6 and SW7, a capacitor C2, a resistor R1, a switch SW2, a resistor R2, a switch SW3, and a control signal generator 33. This reference signal generator 44 is equivalent to the reference signal generator 14 (FIG. 4) from which the capacitor C1 and the switch SW1 are omitted.

FIG. 19 illustrates an example of the operation of the reference signal generator 44: (A) illustrates the waveform of the reference signal RAMP, (B) illustrates the waveform of the control signal S4, (C) illustrates the waveform of the control signal S4B, (D) illustrates the waveform of the control signal S1, (E) illustrates the waveform of the control signal S6, and (F) illustrates the waveform of the control signal S6B.

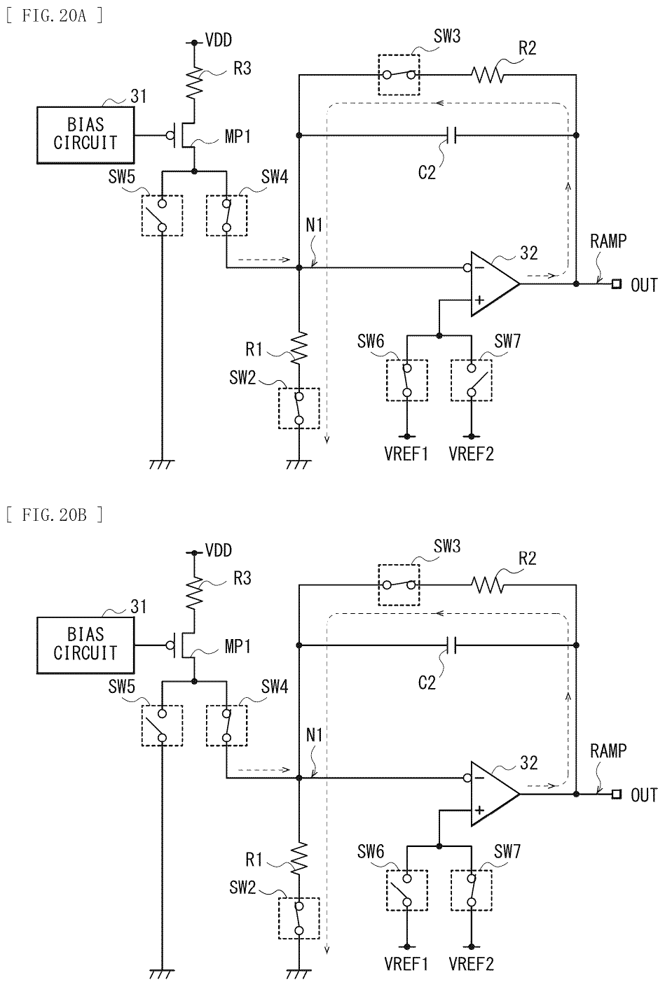

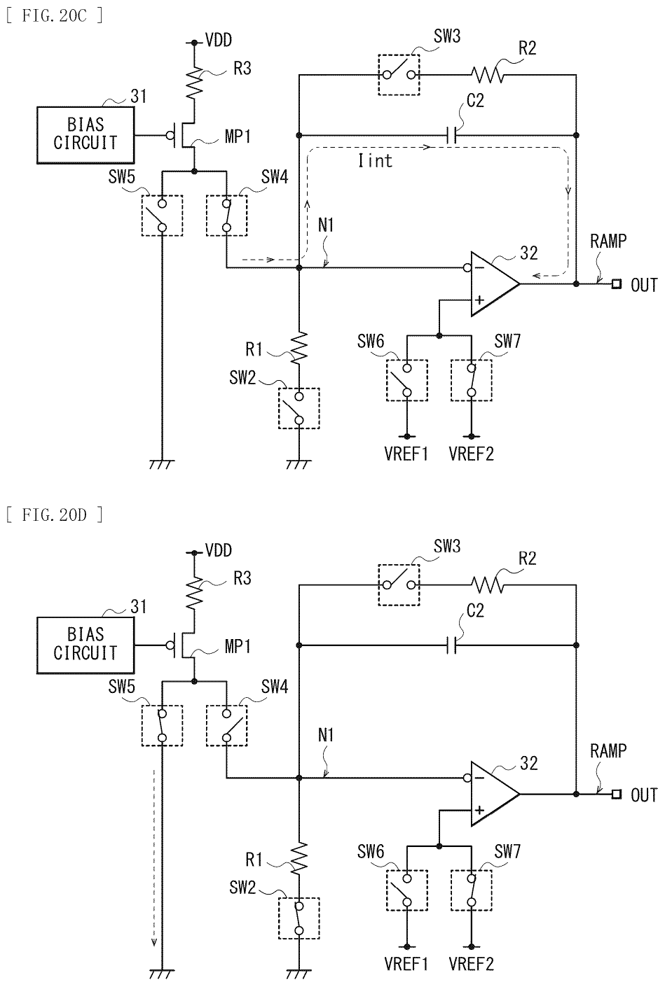

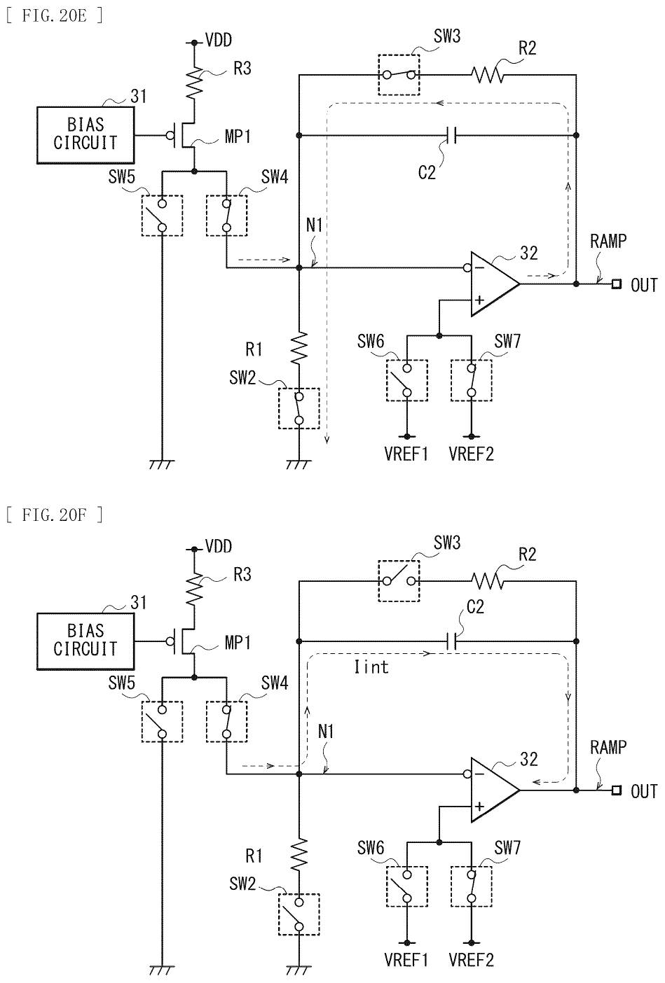

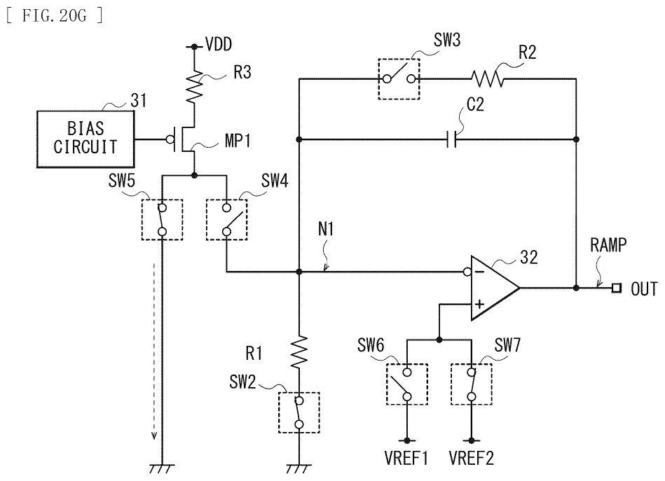

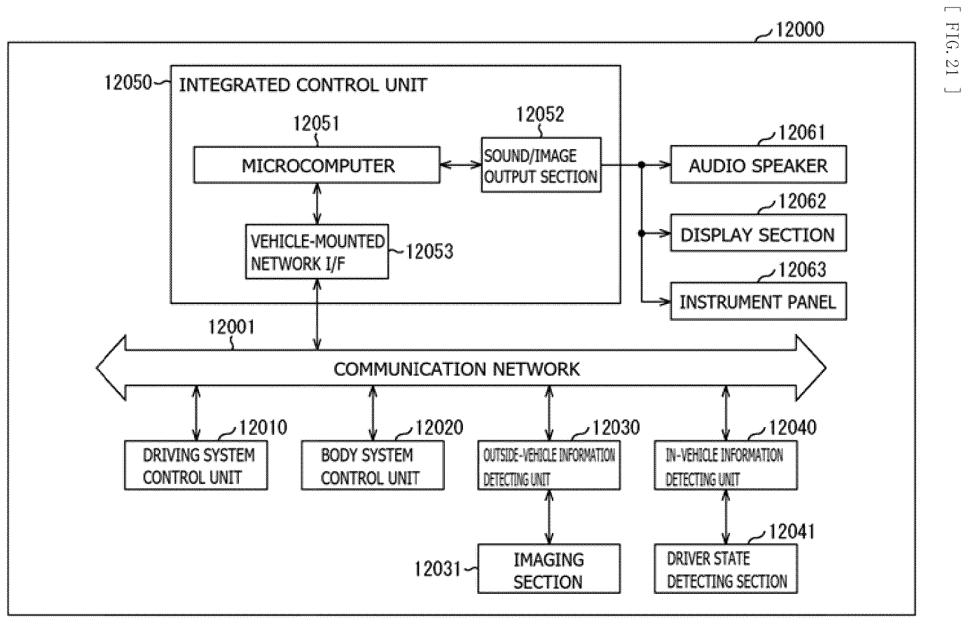

FIGS. 20A to 20G illustrate one operating state of the reference signal generator 44.

First, the control signal generator 33 of the reference signal generator 44 changes the control signals S4, S1, and S6 from low to high at the time t41, and also changes the control signals S4B and S6B from high to low (FIGS. 19(B) to 19(F)). As a result, as illustrated in FIG. 20A, in the reference signal generator 44, the switches SW2 to SW4 and SW6 go into the on state and the switches SW5 and SW7 go into the off state.

Since the switch SW6 is in the on state, the voltage VREF1 is supplied to the positive input terminal of the operation amplifier circuit 32. Since the switches SW2 and SW3 are in the on state, current flows from the output terminal of the operation amplifier circuit 32 to the resistor R2, the switch SW3, the resistor R1, and then the switch SW2. In this example, the voltage at the node N1 is supplied to the negative input terminal of the operation amplifier circuit 32. The voltage at the node N1 is set to the voltage VREF1 by the negative feedback operation of the loop. This voltage at the node N1, the voltage VREF1, is set to allow the transistor MP1 to operate in the saturation region. The feedback gain in this loop is “r1/(r1+r2)”. Here, r1 is the resistance of the resistor R1 and r2 is the resistance of the resistor R2. Therefore, the voltage of the reference signal RAMP is set to the voltage Vo1 expressed by the following equation.

Vo1=VREF1×(r1+r2)/r1

This voltage Vo1 is higher than the voltage VREF1. In this way, the reference signal generator 44 sets the voltage of the reference signal RAMP to the voltage Vo1(FIG. 19(A)). The voltage of the reference signal RAMP changes at the time constant dependent on the resistance of the resistor R2 and the capacitance of the capacitor C2, resulting in the voltage Vo1.

Next, at the time t42, the control signal generator 33 changes the control signal S6 from high to low and also changes the control signal S6B from low to high (FIGS. 19(E) and 19(F)). Accordingly, as illustrated in FIG. 20B, in the reference signal generator 44, the switch SW7 goes into the on state and the switch SW6 goes into the off state.

Since the switch SW7 is in the on state, the voltage VREF2 is supplied to the positive input terminal of the operation amplifier circuit 32. The voltage at the node N1 changes from the voltage VREF1 to the voltage VREF2 due to the negative feedback operation of the loop. The voltage VREF2, which is the voltage at the node N2, is set to allow the transistor MP1 to operate in the saturation region. The feedback gain in this loop is “r1/(r1+r2)”. Therefore, the voltage of the reference signal RAMP is set to the voltage Vo2 expressed by the following equation.

Vo2=VREF2×(r1+r2)/r1

This voltage Vo2 is higher than the voltage VREF2. In this way, the reference signal generator 44 changes the voltage of the reference signal RAMP from the voltage Vo1 to the voltage Vo2 (FIG. 19(A)). The voltage of the reference signal RAMP changes at the time constant dependent on the resistance of the resistor R2 and the capacitance of the capacitor C2, resulting in the voltage Vo2.

Next, the control signal generator 33 changes the control signal S1 from high to low at the time t43 (FIG. 19(D)). Consequently, as illustrated in FIG. 20C, in the reference signal generator 44, the switches SW2 and SW3 go into the off state.

Since the switches SW2 and SW3 are in the off state, as illustrated in FIG. 20C, the current from the transistor MP1 flows into the output terminal of the operation amplifier circuit 32 through the capacitor C2 (current Iint). The capacitor C2 is gradually charged with this current Iint. In other words, the operation amplifier circuit 32 and the capacitor C2 constitute an integrating circuit. In this way, the reference signal generator 44 gradually decreases the voltage of the reference signal RAMP from the voltage Vo2 (FIG. 19(A)).

Next, the control signal generator 33 changes the control signal S4 from high to low and also changes the control signal S4B from low to high at the time t44 (FIGS. 19(B) and 19(C)). Accordingly, as illustrated in FIG. 20D, in the reference signal generator 44, the switch SW4 goes into the off state and the switch SW5 goes into the on state.

Since the switch SW4 is in the off state and the switch SW5 is in the on state, the current from the transistor MP1 flows into the ground node via the switch SW5. This stops charging of the capacitor C2. In this way, the reference signal generator 44 stops change in the voltage of the reference signal RAMP and maintains this voltage (FIG. 19(A)).

Next, the control signal generator 33 changes the control signals S1 and S4 from low to high at the time t45, and also changes the control signal S4B from high to low (FIGS. 19(B) to 19(D)). Consequently, as illustrated in FIG. 20E, in the reference signal generator 44, the switches SW3 to SW4 go into the on state and the switch SW5 goes into the off state.

Since the switches SW2 and SW3 are in the on state, current flows from the output terminal of the operation amplifier circuit 32 to the resistor R2, the switch SW3, the resistor R1, and then the switch SW2. The feedback gain in this loop is “r1/(r1+12)”. Thus, the reference signal generator 44 sets the voltage of the reference signal RAMP to the voltage Vo2 (FIG. 19(A)). The voltage of the reference signal RAMP changes at the time constant dependent on the resistance of the resistor R2 and the capacitance of the capacitor C2, resulting in the voltage Vo2.

Next, the control signal generator 33 changes the control signal S1 from high to low at the time t46 (FIG. 19(D)). Accordingly, as illustrated in FIG. 20F, in the reference signal generator 14, the switches SW2 and SW3 go into the off state.

Since the switches SW2 and SW3 are in the off state, as illustrated in FIG. 20F, the current from the transistor MP1 flows into the output terminal of the operation amplifier circuit 32 via the capacitor C2 (current Iint). The capacitor C2 is gradually charged with this current Iint. In this way, the reference signal generator 44 gradually decreases the voltage of the reference signal RAMP from the voltage Vo2 (FIG. 19(A))

Next, at the time t47, the control signal generator 33 changes the control signal S4 from high to low and also changes the control signal S4B from low to high (FIGS. 19(B) and 19(C)). Accordingly, as illustrated in FIG. 20G, in the reference signal generator 44, the switch SW4 goes into the off state and the switch SW5 goes into the on state.

Since the switch SW4 is in the off state and the switch SW5 is in the on state, the current from the transistor MP1 flows to the ground node via the switch SW5. This stops the charging to the capacitor C2. In this way, the reference signal generator 44 stops change in the voltage of the reference signal RAMP and maintains this voltage (FIG. 19(A)).

The control signal generator 33 repeats this operation performed from the time t41 to the time t48 to generate the reference signal RAMP illustrated in FIG. 19(A).

In the reference signal generator 44, provided are a current source (transistor MP1 and resistor R3) that is configured to flow current from the power supply node of the power supply voltage to the first node (node N1), an operation amplifier circuit 32 that includes a positive input terminal, a negative input terminal coupled to the first node (node N1), and an output terminal coupled to an output node, a first capacitor(capacitor C2) having one end coupled to the first node (node N1) and another end coupled to the output node, a first resistor (resistor R1) provided in the first path connecting the first node (node N1) and the ground node, a second switch (switch SW2) that is provided in the first path and is configured to turn on and off the first path, a second resistor (resistor R1) that is provided in the second path connecting the first node (node N1) and the output node, and a second switch (switch SW3) that is provided in the second path and is configured to turn on and off the second path. Hence, in the reference signal generator 44, it is possible to set the voltage of the node N1 to a low voltage that allows the transistor MP1 to operate in the saturation region, and to set the voltage of the reference signal RAMP at the times t43 and t46 to the voltage Vo2 which is higher than the voltage of the node N1. As a result, in the reference signal generator 44, it is possible to widen the voltage range of the reference signal RAMP and increase the dynamic range.

### [Modification 2]

The technology related to modifications 1-1 to 1-3 of the aforementioned embodiment may be applied to this reference example. Two or more of these may be used in combination.

### 3. Examples of Applications to Mobile Object

The technology according to the present disclosure(the present technology) may be applied to various products. For example, the technology according to the present disclosure may be achieved as a device to be mounted on any one of the following mobile objects: automobiles, electric vehicles, hybrid electric vehicles, motorcycles, bicycles, personal mobility vehicles, airplanes, drones, ships, and robots.

FIG. 21 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 21, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 21, an audio speaker 12061, a display section 12062, and an instrument panel 12063 are illustrated as the output device. The display section 12062 may, for example, include at least one of an on-board display and a head-up display.

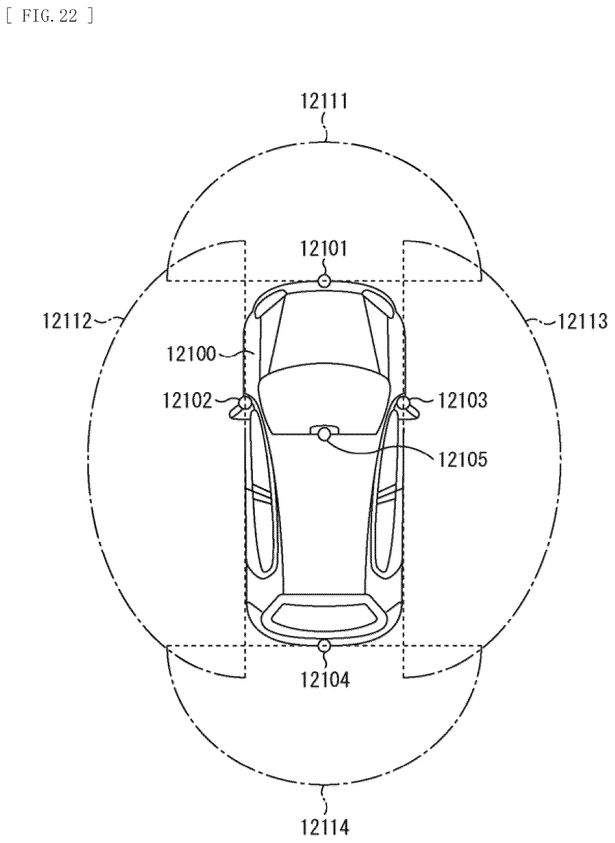

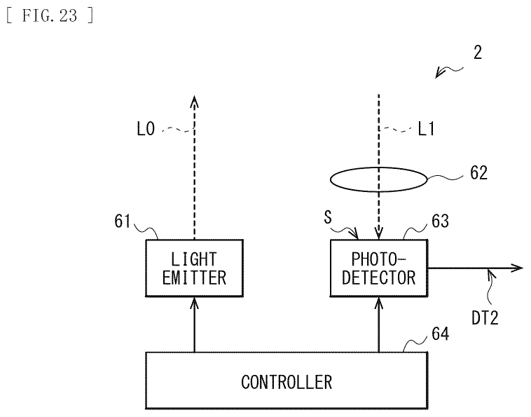

FIG. 22 is a diagram depicting an example of the installation position of the imaging section 12031.

In FIG. 22, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 22 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance(relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control(including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of a vehicle control system to which the technology according to the present disclosure may be applied has been described above. The technology according to the present disclosure may be applied to the imaging section 12031 out of the aforementioned components. In an imaging device mounted on a vehicle, it is possible to enhance the image quality of the captured image. This allows the vehicle control system 12000 to achieve, for example, a collision avoidance or collision mitigation function of a vehicle, a following driving function based on the distance between vehicles, a speed maintenance driving function, a collision warning function of a vehicle, a lane departure warning function of a vehicle with high accuracy.

Although the present technology has been described above taking the embodiment and modifications and specific examples of applications thereof, the present technology is not limited to the embodiment and the like and it is possible to make various modifications.

For example, in the aforementioned embodiment, the present technology is applied to an imaging device; however, this is not necessarily the case, and it is possible to apply the present technology to various devices that detect light. FIG. 23 illustrates an example of the configuration of a distance measuring device 2 to which the present technology is applied. The distance measuring device 2 is an indirection type time-of-flight (ToF) sensor and is configured to measure the distance to a measurement object OBJ. The distance measuring device 2 includes a light emitter 61, an optical system 62, a photodetection apparatus 63, and a controller 64.

The light emitter 51 is configured to emit light pulses LO toward the measurement object OBJ according to an instruction from the controller 54. The light emitter 61 is configured to emit light pulses LO by performing a light emission operation that alternately repeats emission and non-emission according to an instruction from the controller 64. The light emitter 61 has a light source that emits, for example, infrared light. This light source includes, for example, a laser light source or light emitting diode (LED).

The optical system 62 includes a lens that forms an image on the light-receiving surface S of a photodetection apparatus 63. Light pulses (reflected light pulses L1) omitted from the light emitter 61 and reflected by the measurement object OBJ enter the optical system 62.

The photodetection apparatus 63 is configured to generate a distance image by detecting light according to an instruction from the controller 64. A plurality of pixel values included in the distance image each indicates a value related to a distance D to the measurement object OBJ. The photodetection apparatus 63 is configured to output the generated distance image as image data DT2.

The controller 64 is configured to supply control signals to the light emitter 61 and the photodetection apparatus 63 and control their operation, thereby controlling the operation of the distance measuring device 2.

Even in such a distance measuring device 2, it is possible to perform AD conversion on the basis of the reference signal RAMP. Applying this technology makes it possible to improve the accuracy of distance measurement in the distance measuring device 2.

The effects described herein are merely illustrative and are not limited, and there may be other effects.

Note that it is possible to configure the technology as follows. The following configuration makes it possible to increase the dynamic range of signals to be generated.

(1)

A signal generation circuit including:

a current source that is configured to flow a current from a first power supply node to a first node;

a first capacitor that has one end coupled to the first node and another end coupled to a second node;

an operation amplifier circuit that has a positive input terminal, a negative input terminal coupled to the second node, and an output terminal coupled to an output node;

a first switch that has one end coupled to the second node and another end coupled to the output node;

a second capacitor that has one end coupled to the first node and another end coupled to the output node;

a first resistor that is provided in a first path that couples the first node and a second power supply node; and

a second switch that is provided in the first path and is configured to turn on and off the first path.

(2)

The signal generation circuit according to (1), further including:

a second resistor that is provided in a second path that couples the first node and the output node; and

a third switch that is provided in the second path and is configured to turn on and off the second path.

(3)

The signal generation circuit according to (1) or(2), in which

the current source includes
a third resistor that has one end and another end, the one end being coupled to the first power supply node, and
a transistor that has a gate, a source, and a drain, the source being coupled to the other end of the third resistor, the drain being led to the first node.

(4)

The signal generation circuit according to any one of (1) to(3), further including:

a fourth switch that is provided in a path that couples the current source and the first node; and

a fifth switch that is provided in a path that couples the current source and the second power supply node.

(5)

The signal generation circuit according to any one of (1) to(4), further including:

a sixth switch that is coupled to the positive input terminal of the operation amplifier circuit and is configured to supply a first voltage to the positive input terminal by going into an on state; and

a seventh switch that is coupled to the positive input terminal of the operation amplifier circuit and is configured to supply a second voltage to the positive input terminal by going into an on state.

(6)

The signal generation circuit according to (1), further including:

a controller that controls operation of the first switch and the second switch, wherein the controller is configured to
bring the first switch and the second switch into an on state in a first period, and
bring the first switch and the second switch into an off state in a second period that is after the first period, and

the signal generation circuit is configured to generate, in the second period, a signal whose voltage varies with time.

(7)

The signal generation circuit according to (6), further including:

a second resistor that is provided in a second path that couples the first node and the output node; and

a third switch that is provided in the second path and is configured to turn on and off the second path, wherein

the controller is configured to
bring the third switch into an on state in the first period, and
bring the third switch into an off state in the second period.

(8)

The signal generation circuit according to (6) or(7), further including:

a fourth switch that is provided in a path that couples the current source and the first node; and

a fifth switch that is provided in a path that couples the current source and the second power supply node, wherein

the controller is configured to bring the fourth switch into an on state in the second period.

(9)

A photodetection apparatus including:

a photodetection circuit that is configured to generate, by detecting light, a detection signal having a voltage dependent on an amount of received light;

a signal generation circuit that is configured to generate a reference signal whose voltage varies with time; and

a comparison circuit that is configured to perform a comparison operation on the basis of the detection signal and the reference signal, wherein

the signal generation circuit includes
a current source that is configured to flow a current from a first power supply node to a first node,
a first capacitor that has one end coupled to the first node and another end coupled to a second node,
an operation amplifier circuit that has a positive input terminal, a negative input terminal coupled to the second node, and an output terminal coupled to an output node,
a first switch that has one end coupled to the second node and another end coupled to the output node,
a second capacitor that has one end coupled to the first node and another end coupled to the output node,
a first resistor that is provided in a first path that couples the first node and a second power supply node, and
a second switch that is provided in the first path and is configured to turn on and off the first path.

(10)

A signal generation circuit including:

a current source that is configured to flow a current from a first power supply node to a first node;

an operation amplifier circuit that has a positive input terminal, a negative input terminal coupled to the first node, and an output terminal coupled to an output node;

a first capacitor that has one end coupled to the first node and another end coupled to the output node;

a first resistor that is provided in a first path that couples the first node and a second power supply node;

a second switch that is provided in the first path and is configured to turn on and off the first path;

a second resistor that is provided in a second path that couples the first node and the output node; and

a third switch that is provided in the second path and is configured to turn on and off the second path.

(11)

A photodetection apparatus including:

a photodetection circuit that is configured to generate, by detecting light, a detection signal having a voltage dependent on an amount of received light;

a signal generation circuit that is configured to generate a reference signal whose voltage varies with time; and

a comparison circuit that is configured to perform a comparison operation on the basis of the detection signal and the reference signal, in which

the signal generation circuit includes
a current source that is configured to flow a current from a first power supply node to a first node;
an operation amplifier circuit that has a positive input terminal, a negative input terminal coupled to the first node, and an output terminal coupled to an output node;
a first capacitor that has one end coupled to the first node and another end coupled to the output node;
a first resistor that is provided in a first path that couples the first node and a second power supply node;
a second switch that is provided in the first path and is configured to turn on and off the first path;
a second resistor that is provided in a second path that couples the first node and the output node; and
a third switch that is provided in the second path and is configured to turn on and off the second path.

The present application claims the benefit of Japanese Priority Patent Application JP2022-020876 filed with the Japan Patent Office on Feb. 14, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A signal generation circuit comprising:
a current source that is configured to flow a current from a first power supply node to a first node;
a first capacitor that has one end coupled to the first node and another end coupled to a second node;
an operation amplifier circuit that has a positive input terminal, a negative input terminal coupled to the second node, and an output terminal coupled to an output node;
a first switch that has one end coupled to the second node and another end coupled to the output node;
a second capacitor that has one end coupled to the first node and another end coupled to the output node;
a first resistor that is provided in a first path that couples the first node and a second power supply node; and
a second switch that is provided in the first path and is configured to turn on and off the first path.

2. The signal generation circuit according to claim 1, further comprising:
a second resistor that is provided in a second path that couples the first node and the output node; and
a third switch that is provided in the second path and is configured to turn on and off the second path.

3. The signal generation circuit according to claim 1, wherein
the current source includes
a third resistor that has one end and another end, the one end being coupled to the first power supply node, and
a transistor that has a gate, a source, and a drain, the source being coupled to the other end of the third resistor, the drain being led to the first node.

4. The signal generation circuit according to claim 1, further comprising:
a fourth switch that is provided in a path that couples the current source and the first node; and
a fifth switch that is provided in a path that couples the current source and the second power supply node.

5. The signal generation circuit according to claim 1, further comprising:
a sixth switch that is coupled to the positive input terminal of the operation amplifier circuit and is configured to supply a first voltage to the positive input terminal by going into an on state; and
a seventh switch that is coupled to the positive input terminal of the operation amplifier circuit and is configured to supply a second voltage to the positive input terminal by going into the on state.

6. The signal generation circuit according to claim 1, further comprising:
a controller that controls operation of the first switch and the second switch, wherein the controller is configured to
bring the first switch and the second switch into an on state in a first period, and
bring the first switch and the second switch into an off state in a second period that is after the first period, and
the signal generation circuit is configured to generate, in the second period, a signal whose voltage varies with time.

7. The signal generation circuit according to claim 6, further comprising:
a second resistor that is provided in a second path that couples the first node and the output node; and
a third switch that is provided in the second path and is configured to turn on and off the second path, wherein
the controller is configured to
bring the third switch into an on state in the first period, and
bring the third switch into an off state in the second period.

8. The signal generation circuit according to claim 6, further comprising:
a fourth switch that is provided in a path that couples the current source and the first node; and
a fifth switch that is provided in a path that couples the current source and the second power supply node, wherein
the controller is configured to bring the fourth switch into an on state in the second period.

9. A photodetection apparatus comprising:
a photodetection circuit that is configured to generate, by detecting light, a detection signal having a voltage dependent on an amount of received light;
a signal generation circuit that is configured to generate a reference signal whose voltage varies with time; and
a comparison circuit that is configured to perform a comparison operation on a basis of the detection signal and the reference signal, wherein
the signal generation circuit includes
a current source that is configured to flow a current from a first power supply node to a first node,
a first capacitor that has one end coupled to the first node and another end coupled to a second node,
an operation amplifier circuit that has a positive input terminal, a negative input terminal coupled to the second node, and an output terminal coupled to an output node,
a first switch that has one end coupled to the second node and another end coupled to the output node,
a second capacitor that has one end coupled to the first node and another end coupled to the output node,
a first resistor that is provided in a first path that couples the first node and a second power supply node, and
a second switch that is provided in the first path and is configured to turn on and off the first path.
